(19) United States
(12) Patent Application Publication
(10) Pub. No.: US 2019/0364006 A1
(43) Pub. Date: Nov. 28, 2019

(54) Email Grouping Method and Apparatus

(71) Applicant: Huawei Technologies Co., Ltd., Shenzhen (CN)

(72) Inventors: Guocheng Hu, Shenzhen (CN); Hongjie Yao, Shenzhen (CN)

(21) Appl. No.: 16/464,456

(22) PCT Filed: Nov. 25, 2016
(86) PCT No.: PCT/CN2016/107347

§ 371 Date: May 28, 2019

(51) Int. Cl. H04L 12/58; G06K 9/62

(52) U.S. Cl. CPC H04L 51/22; G06K 9/6267; H04L 51/38

(57) ABSTRACT

An email grouping method includes determining at least one initial subject email in a plurality of to-be-grouped emails in an email box, and classifying the to-be-grouped email into an email group corresponding to the initial subject email, for each of the plurality of to-be-grouped emails, when the to-be-grouped email includes an email subject of any one of the at least one initial subject email or includes the email subject and an email additional character, where each of the at least one initial subject email corresponds to one email group, and the email additional character includes at least one of a default character and a non-default character.

### TECHNICAL FIELD

The present invention relates to the field of communications technologies, and in particular, to an email grouping method and apparatus.

### BACKGROUND

With development of network technologies, network communication tools such as emails are more frequently used, and there are an increasing number of emails sent or received by using email boxes (for example, Foxmail and Outlook). To facilitate management of an email box, emails in the email box may be grouped.

In the prior art, a plurality of emails in an email box may be grouped based on an email “subject”. Specifically, when the emails are grouped, a default character included in an email subject of each email may be neglected, and emails having a same email subject in the email box are classified into a same email group. The default character may include at least one of reply characters such as “reply:”, “re:”, “forward:” and “RE:” that are automatically added into the email subject of the email by the email box in an email receiving and sending process. For example, in the email grouping method in the prior art, an email having an email subject of “reply: sbfl2s” and an email having an email subject of “sbfl2s” may be classified into a same email group.

When the emails are grouped by using the method in the prior art, only the default character can be neglected, and therefore in the email receiving and sending process, if a user manually adds at least one non-default character (that is, a character or text other than the default character) into an email subject (for example, a subject a) of an email, by using the method in the prior art, an email having an email subject of “subject a+the non-default character” and an email having an email subject of “subject a” and an email having an email subject of “subject a+the default character” are classified into email groups corresponding to different email subjects. That is, by using the email grouping method in the prior art, all emails having related email subjects in the emails cannot be classified into a same email group, and a problem that grouping performed on emails in an email box cannot achieve an expected effect exists in the prior art.

### SUMMARY

Embodiments of this application provide an email grouping method and apparatus, to resolve a problem that grouping of emails in an email box cannot achieve an expected effect.

To achieve the foregoing objective, the following technical solutions are used in the embodiments of this application.

According to a first aspect, an embodiment of this application provides an email grouping method, and the email grouping method includes: determining at least one initial subject email in a plurality of to-be-grouped emails in an email box, where an email subject of each of the at least one initial subject email is included in at least one other email in the plurality of to-be-grouped emails, and the initial subject email does not include an email subject of any one of the at least one other email; and then for each of the plurality of to-be-grouped emails, if the to-be-grouped email includes an email subject of any one of the at least one initial subject email or includes the email subject and an email additional character of the initial subject email, classifying the to-be-grouped email into an email group corresponding to the initial subject email, where each of the at least one initial subject email corresponds to one email group, and the email additional character includes at least one of a default character and a non-default character.

In this solution, the at least one initial subject email may be determined in the plurality of to-be-grouped emails in the email box. The email subject of the initial subject email is included in the at least one other email in the plurality of to-be-grouped emails, and the initial subject email does not include the email subject of any one of the at least one other email, that is, the initial subject email in this solution may be an email whose email subject does not include the default character (such as “reply:” and “RE”) and the non-default character (that is, in an email receiving and sending process, a character or text that is manually added by the user into an email subject of an email other than the default character). Therefore, for the email group to which any one of the at least one initial subject email belongs, regardless of whether the email additional character included in the email subject of the to-be-grouped email is the default character or the non-default character, provided that the to-be-grouped email includes the email subject of the initial subject email, the to-be-grouped email may be classified into the email group. In this way, a problem in the prior art that grouping performed on a plurality of to-be-grouped emails in an email box cannot achieve an expected effect can be resolved.

In a possible implementation, before the determining at least one initial subject email in a plurality of to-be-grouped emails, the email grouping method may further include: receiving a subject keyword entered by a user; and retrieving an email matching the subject keyword from the email box, to obtain at least one matching email, where each of the at least one matching email matches the subject keyword, and the plurality of to-be-grouped emails include emails in the email box other than the at least one matching email.

Before determining the initial subject email and grouping the plurality of to-be-grouped emails, in the method in this embodiment of this application, the at least one matching email may further be determined based on the subject keyword entered by the user, and then the emails in the email box other than the at least one matching email are grouped by using the email grouping method.

In a possible implementation, after the “for each of the plurality of to-be-grouped emails, if the to-be-grouped email includes an email subject of any one of the at least one initial subject email, classifying the to-be-grouped email into an email group corresponding to the initial subject email”, the email grouping method further includes: aggregating all emails in each email group into one aggregated email based on a chronological order of email sending time, where the aggregated email corresponding to each email group includes information about all the emails in the email group.

The emails included in each email group include the email subject of the initial subject email corresponding to the email group, that is, all emails in the email group are emails based on one email subject (the email subject of the initial subject email). Therefore, in this application, all emails in each email group may be aggregated into one aggregated email based on the chronological order of email sending time, where all emails in the aggregated email are based on one email subject (the email subject of the initial subject email). In this way, after all emails in an email group are aggregated into one aggregated email based on a chronological order of email sending time, a user may conveniently check all the emails in the email group based on a chronological order of email sending time.

In a possible implementation, that an email subject of each of the at least one initial subject email is included in at least one other email in the plurality of to-be-grouped emails is specifically: the email subject of each initial subject email is included in an email body or an email subject of the at least one other email in the plurality of to-be-grouped emails; and “the initial subject email does not include an email subject of any one of the at least one other email” includes: neither the email subject nor an email body of the initial subject email includes the email subject of any one of the at least one other email.

It may be figured out that, when performing operations such as replying or forwarding an email received in the email box, the user may modify an email subject of the received email. For example, the user may add a default character or a non-default character into the email subject of the received email, and may further delete a character of the email subject of the received email. In this way, a problem that “after the email subject of the received email is modified, the email subject does not include an email subject of an initial subject email corresponding to the email subject of the received email” may exist. Based on this case, in this application, when the initial subject email is determined, the email subject of each initial subject email not only can be included in the email subject of the at least one other email in the plurality of to-be-grouped emails, but may further be included in the email body of the at least one other email in the plurality of to-be-grouped emails. Alternatively, neither the email subject nor an email body of the initial subject email includes the email subject of any one of the at least one other email.

In a possible implementation, the “if the to-be-grouped email includes an email subject of any one of the at least one initial subject email or includes the email subject and an email additional character of the initial subject email, classifying the to-be-grouped email into an email group corresponding to the initial subject email” may be specifically: if the email subject or the email body of the to-be-grouped email includes the email subject of any one of the at least one initial subject email or includes the email subject and an email additional character of the initial subject email, classifying the to-be-grouped email into an email group corresponding to the initial subject email.

In a possible implementation, the email grouping method further includes: detecting a new email received in the email box or a new email sent from the email box: and if the new email includes the email subject of any one of the at least one initial subject email, classifying the new email into the email group corresponding to the initial subject email.

In the process of performing the email grouping, the new email may be received in or the new email may be sent from the email box. In the method of this application, when the new email received in or the new email sent from the email box is detected, an email subject that is of an initial subject email in the at least one initial subject email and that is included in the new email may be determined, and the new email is classified into an email group to which the corresponding initial subject email belongs.

In a possible implementation, the method of this application may further include: if the new email (an email subject or an email body of the new email) does not include the email subject of any one of the at least one initial subject email, creating a new email group, and classifying the new email into the new email group.

In a possible implementation, after the new email is classified into the email group to which the corresponding initial subject email corresponds, the new email may further be re-aggregated with the aggregated email corresponding to the email group to which the new email belongs, to obtain a new aggregated email. Specifically, after the “if the new email includes the email subject of any one of the at least one initial subject email, classifying the new email into the email group corresponding to the initial subject email”, the email grouping method further includes: aggregating, based on a chronological order of email sending time, the new email and the aggregated email corresponding to the email group to which the new email belongs into a new aggregated email, where the new aggregated email includes information about the new email and information about the aggregated email.

According to a second aspect, an email grouping apparatus is provided, and the email grouping apparatus includes a determining module and a grouping module. The determining module is configured to determine at least one initial subject email in a plurality of to-be-grouped emails in an email box, where an email subject of each of the at least one initial subject email is included in at least one other email in the plurality of to-be-grouped emails, and the initial subject email does not include an email subject of any one of the at least one other email. The grouping module is configured to: for each of the plurality of to-be-grouped emails, if the to-be-grouped email includes an email subject of any one of the at least one initial subject email or includes the email subject and an email additional character of the initial subject email, classify the to-be-grouped email into an email group corresponding to the initial subject email, where each of the at least one initial subject email corresponds to one email group, and the email additional character includes at least one of a default character and a non-default character.

In a possible implementation, the apparatus further includes a receiving module and a matching module. The receiving module is configured to: before the determining module determines the at least one initial subject email in the plurality of to-be-grouped emails, receive a subject keyword entered by a user. The matching module is configured to retrieve, from the email box, an email matching the subject keyword received by the receiving module, to obtain at least one matching email, where each of the at least one matching email matches the subject keyword, and the plurality of to-be-grouped emails include emails in the email box other than the at least one matching email.

In a possible implementation, the apparatus further includes an aggregation module. The aggregation module is configured to: after the grouping module classifies, if for each of the plurality of to-be-grouped emails, the to-be-grouped email includes an email subject of any one of the at least one initial subject email, the to-be-grouped email in an email group corresponding to the initial subject email, aggregate all emails in each email group into one aggregated email based on a chronological order of email sending time, where the aggregated email corresponding to each email group includes information about all the emails in the email group.

In a possible implementation, that an email subject of each of the at least one initial subject email is included in at least one other email in the plurality of to-be-grouped emails is specifically: the email subject of each initial subject email is included in an email body or an email subject of the at least one other email in the plurality of to-be-grouped emails. That the initial subject email does not include an email subject of any one of the at least one other email includes: neither the email subject nor an email body of the initial subject email includes the email subject of any one of the at least one other email.

In a possible implementation, the apparatus further includes a detection module. The detection module is configured to detect a new email received in the email box or a new email sent from the email box. The grouping module is further configured to: if the new email includes the email subject of any one of the at least one initial subject email, classify the new email into the email group that corresponds to the initial subject email.

In a possible implementation, the aggregation module is further configured to: after the grouping module classifies, if the new email includes the email subject of any one of the at least one initial subject email, the new email in the email group corresponding to the initial subject email, aggregate, based on a chronological order of email sending time, the new email and the aggregated email corresponding to the email group to which the new email belongs into a new aggregated email, where the new aggregated email includes information about the new email and information about the aggregated email.

Each function module in the second aspect of this application is logical division performed on the email grouping apparatus to perform the email grouping method of the first aspect. For detailed descriptions and beneficial effect analysis of the function modules in the second aspect, refer to corresponding descriptions and technical effects in the first aspect, and details are not described herein again.

According to a third aspect, an email grouping apparatus is provided, and the email grouping apparatus includes a processor, a memory, and a bus. The memory is configured to store a computer-executable instruction, and the processor is connected to the memory by using the bus. When the email grouping apparatus runs, the processor executes the computer-executable instruction stored in the memory, so that the email grouping apparatus performs the email grouping method according to the first aspect and any possible implementation of the first aspect.

According to a fourth aspect, a nonvolatile storage medium is provided. The nonvolatile storage medium stores one or more pieces of program code. When the processor of the email grouping apparatus in the third aspect executes the program code, the email grouping apparatus performs the email grouping method in the first aspect and the various optional manners of the first aspect.

It should be noted that, the processor in the third aspect of this application may be integration of the function modules in the second aspect such as the determining module, the grouping module, the matching module, and the aggregation module, and the processor may implement functions of the function modules in the second aspect. For detailed descriptions and beneficial effect analysis of the modules in the second aspect and the third aspect, refer to corresponding descriptions and technical effects in the first aspect and the various possible implementations of the first aspect, and details are not described herein again.

### BRIEF DESCRIPTION OF DRAWINGS

FIG. 1 is a schematic diagram of a network architecture of an email transmission system according to an embodiment of the present invention;

FIG. 2 is a schematic structural diagram of hardware of a terminal device according to an embodiment of the present invention:

FIG. 3 is a schematic diagram of an instance of a display screen of another email box according to an embodiment of the present invention;

FIG. 4 is a schematic diagram of an instance of a display screen of another email box according to an embodiment of the present invention;

FIG. 5 is a schematic diagram of an instance of a display screen of another email box according to an embodiment of the present invention;

FIG. 6 is a schematic diagram of an instance of a display screen of another email box according to an embodiment of the present invention;

FIG. 7 is a schematic diagram of an instance of a display screen of another email box according to an embodiment of the present invention;

FIG. 8 is a schematic diagram of an instance of a display screen of another email box according to an embodiment of the present invention;

FIG. 9 is a schematic diagram of an instance of a display screen of another email box according to an embodiment of the present invention;

FIG. 10 is a flowchart of an email grouping method according to an embodiment of the present invention;

FIG. 11 is a schematic diagram of an instance of a display screen of another email box according to an embodiment of the present invention;

FIG. 12 is a flowchart of an email grouping method according to an embodiment of the present invention;

FIG. 13 is a schematic diagram of an instance of a display screen of another email box according to an embodiment of the present invention;

FIG. 14 is a schematic diagram of an instance of a display screen of another email box according to an embodiment of the present invention;

FIG. 15 is a schematic diagram of an instance of a display screen of another email box according to an embodiment of the present invention:

FIG. 16 is a schematic diagram of an instance of a display screen of another email box according to an embodiment of the present invention;

FIG. 17 is a flowchart of an email grouping method according to an embodiment of the present invention;

FIG. 18 is a schematic diagram of an instance of a display screen of another email box according to an embodiment of the present invention;

FIG. 19 is a schematic diagram of an instance of a display screen of another email box according to an embodiment of the present invention;

FIG. 20 is a schematic diagram of an instance of a display screen of another email box according to an embodiment of the present invention;

FIG. 21 is a flowchart of an email grouping method according to an embodiment of the present invention:

FIG. 22 is a schematic diagram of an instance of a display screen of another email box according to an embodiment of the present invention:

FIG. 23 is a schematic diagram of an instance of a display screen of another email box according to an embodiment of the present invention;

FIG. 24 is a flowchart of an email grouping method according to an embodiment of the present invention:

FIG. 25 is a schematic structural composition diagram of a terminal device according to an embodiment of the present invention;

FIG. 26 is a schematic structural composition diagram of another terminal device according to an embodiment of the present invention;

FIG. 27 is a schematic structural composition diagram of another terminal device according to an embodiment of the present invention;

FIG. 28 is a schematic structural composition diagram of another terminal device according to an embodiment of the present invention;

FIG. 29 is a schematic structural composition diagram of another terminal device according to an embodiment of the present invention: and

FIG. 30 is a schematic structural composition diagram of another terminal device according to an embodiment of the present invention.

### DESCRIPTION OF EMBODIMENTS

Embodiments of the present invention provide an email grouping method and apparatus. The email grouping method and apparatus may be applied to a process in which a plurality of emails in an email box are managed, and are specifically applied to a process in which a plurality of to-be-grouped emails in an email box are grouped.

Referring to FIG. 1, FIG. 1 shows a network architecture of an email transmission system 10 according to an embodiment of the present invention. As shown in FIG. 1, the email transmission system 10 may include at least two terminal devices (for example, a terminal device 11 and a terminal device 12) on which an email box is installed and at least two email servers (for example, an email server 21 and an email server 22). The email server in this embodiment of the present invention is a device responsible for email receiving and sending and management. For example, as shown in FIG. 1, the email server 21 is responsible for email receiving and sending and management in the email box of the terminal device 11, and the email server 22 is responsible for email receiving and sending and management in the email box of terminal device 12.

For example, after receiving an email sent by the terminal device 11 by using the email box of the terminal device 11, the email server 21 may forward the email based on a destination address of the email. For example, if the destination address of the email is an email address of the email box of the terminal device 12, the email server 21 may forward the email to the email server 22, and the email server 22 forwards the email to the terminal device 12, so that a recipient of the email may download and check the email in the email box of the terminal device 12.

The email grouping method provided in this embodiment of the present invention may be performed by an email grouping apparatus. The email grouping apparatus may be a terminal device (for example, the terminal device 11 shown in FIG. 1) on which an email box is installed, or a central processing unit (English: Central Processing Unit, CPU for short) of the terminal device on which the email box is installed, or a control module that is in the terminal device and that is configured to manage the email box. In this embodiment of the present invention, that the email grouping method is performed by using a terminal device is used as an example, to describe the email grouping method provided in this embodiment of the present invention.

For example, the terminal device may be an electronic device on which an email box may be installed, for example, a personal computer (English: Personal Computer, PC for short), a mobile phone, a tablet computer, or a portable computer. It should be noted that, all mails in this embodiment of the present invention are emails. For example, the email box may be any one of Outlook, Foxmail. and the like.

For the email box installed on the terminal device in this embodiment of the present invention, a format of an email address of the email box may be user name@domain name, for example, Steven@outlook.com. A user name is an identifier set by a user for an email box of the user when the user of the email box registers the email box, to distinguish the email box from another email box having a same domain name. A domain name is an identifier of different types of email box.

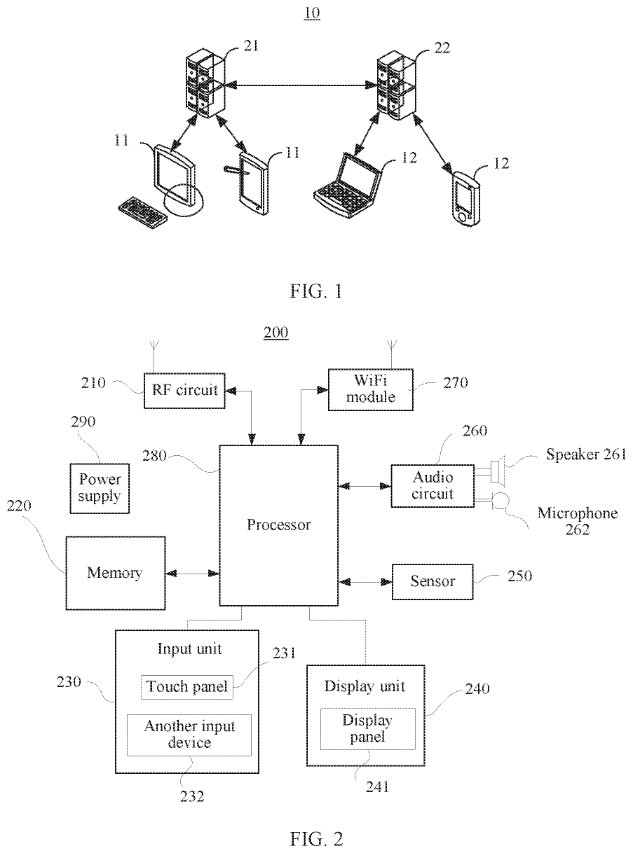

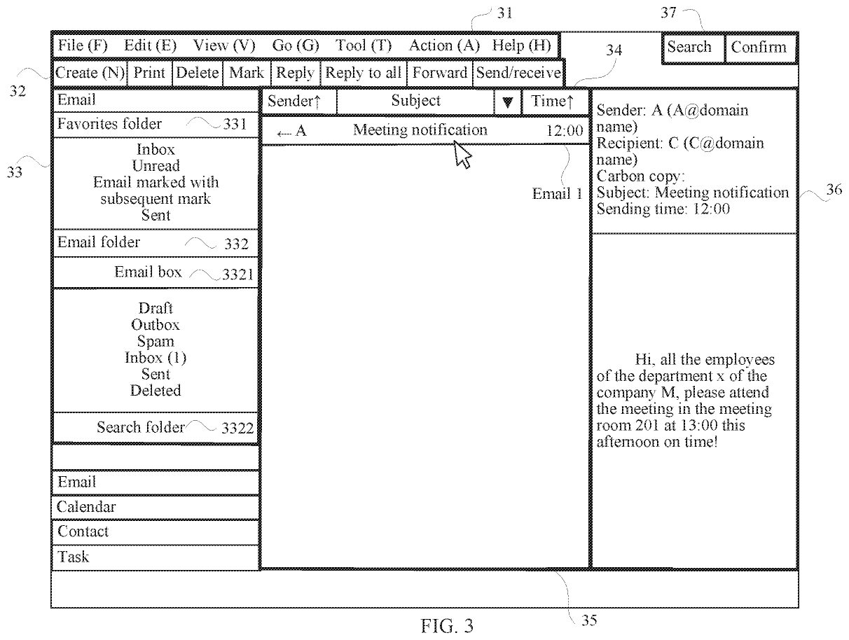

FIG. 2 is a schematic structural diagram of a terminal device according to an embodiment of the present invention. The terminal device provided in this embodiment of the present invention may be configured to implement the method implemented in each embodiment of the present invention. For ease of description, only parts related to this embodiment of the present invention are shown. For specific technical details that are not disclosed, refer to the embodiments of the present invention.

That the terminal device is a mobile phone is used as an example to describe this embodiment of the present invention. FIG. 2 is a block diagram of a part of a structure of the mobile phone 200 related to the embodiments of the present invention. The mobile phone 200 in FIG. 2 includes components such as a radio frequency (English: Radio Frequency, RF for short) circuit 210, a memory 220, an input unit 230, a display unit 240, a sensor 250, an audio circuit 260, a wireless fidelity (English: wireless fidelity, WiFi for short) module 270, a processor 280, and a power supply 290. Persons skilled in the art may understand that the structure of the mobile phone shown in FIG. 2 does not constitute a limitation to the mobile phone, and the mobile phone may include more components or fewer components than those shown in the figure, or some components may be combined, or a different component deployment may be used.

The RF circuit 210 may be configured to receive and send a signal in an information receiving and sending process; and may further communicate with another device by using wireless communication and a network (for example, receiving an email sent by another device). The memory 220 may be configured to store a software program and module and data information. For example, the memory 220 may be configured to store an email box client of the mobile phone 200 and an email sent or received by the RF circuit 210 by using the email box client.

The input unit 230 may be configured to receive entered text or a character, and generate a signal input related to the user setting and function control of the mobile phone 200. For example, the input unit 230 may be configured to receive the text or the character entered by a user for searching an email. Specifically, the input unit 230 may include a touch panel 231 and another input device 232. The touch panel 231 may also be referred to as a touchscreen, and may collect a touch operation of the user on or near the touch panel (such as an operation of the user on or near the touch panel 231 by using any suitable object or attachment, such as a finger or a touch pen), and drive a corresponding connection apparatus according to a preset program. Optionally, the touch panel 231 may include two parts: a touch detection apparatus and a touch controller. The touch detection apparatus detects a touch position of the user, detects a signal generated by the touch operation, and transfers the signal to the touch controller. The touch controller receives touch information from the touch detection apparatus, converts the touch information into touch point coordinates, and sends the touch point coordinates to the processor 280. Moreover, the touch controller can receive and execute a command sent by the processor 280. In addition, the touch panel 231 may be a resistive, capacitive, infrared, or surface sound wave type touch panel. In addition to the touch panel 231, the input unit 230 may further include the another input device 232. Specifically, the another input device 232 may include, but is not limited to: one or more of a physical keyboard, a functional key (such as a volume control key or a switch key), a track ball, a mouse, and a joystick.

The display unit 240 may be configured to display information entered by the user or information provided for the user, and various menus of the mobile phone 200. The display unit 240 may include a display panel 241. Optionally, the display panel 241 may be configured by using a liquid crystal display (English: Liquid Crystal, LCD Display for short), an organic light-emitting diode (English: Organic Light-Emitting Diode, OLED for short), or the like. Further, the touch panel 231 may cover the display panel 241. After detecting a touch operation on or near the touch panel 231, the touch panel 231 transfers the touch operation to the processor 280, to determine a type of a touch event. Then, the processor 280 provides corresponding visual output on the display panel 241 according to the type of the touch event.

Although, in FIG. 2, the touch panel 231 and the display panel 241 are used as two separate parts to implement input and output functions of the mobile phone 200, in some embodiments, the touch panel 231 and the display panel 241 may be integrated to implement the input and output functions of the mobile phone 200.

The mobile phone 200 may further include at least one sensor 250, such as a light sensor, a motion sensor, and other sensors. The audio circuit 260, a speaker 261, and a microphone 262 may provide audio interfaces between the user and the mobile phone 200. The audio circuit 160 may convert received audio data into an electrical signal and transmit the electrical signal to the speaker 161. The speaker 161 converts the electrical signal into a sound signal for output. On the other hand, the microphone 162 converts a collected sound signal into an electrical signal. The audio circuit 160 receives the electrical signal and converts the electrical signal into audio data, and outputs the audio data to the RF circuit 210 to send the audio data to, for example, another mobile phone (for example, adding the audio data into an email in a process in which an email is sent from or received in an email box client), or outputs the audio data to the memory 220 for further processing.

The terminal devices such as the PC, the mobile phone, the tablet computer, or the portable computer may all include the display unit 240, and when an email box client is installed on any one of the terminal devices, the display unit 240 of the terminal device may be used as a display screen of the email box client of the terminal device. The email box client is stored in the memory 220 of the terminal device (for example, the mobile phone 200). When the user clicks an email client icon on the display unit 240, the processor 280 calls the display screen of the email box client stored in the memory 220. The display screen of the email box client of the terminal device may be a graphical user interface (English: Graphical User Interface, GUI for short), and the GUI includes graphical options in a text form and an icon form. Both the graphical option in the text form and the graphical option in the icon form of the GUI may be operated by the user by touching the display unit 240 (for example, the touchscreen) or by using another input device (for example, a mouse). It should be noted that, in this embodiment of the present invention, except for the details in FIG. 2, for ease of representation, the “email box client” is briefly referred to as the “email box”, and the “display screen of the email box client” is briefly referred to as the “display screen of the email box”.

The GUI is a display screen that is of a terminal device (for example, the PC) and that is displayed in a graphical manner. The graphical option of the GUI may include a text form and an icon form, the graphs may be operated by the user, and the graphs may be viewed and operated by the user in the GUI. Specifically, the GUI is a display format of a display screen in which the user communicates with the terminal device (for example, the PC), and allows the user to manipulate an option in the icon form or an option in the text form on a screen (equaling to a display) by using an input device such as the mouse, to perform operations such as giving a command, calling a file, and starting a program, or execute some other routine tasks.

The GUI includes a window, a drop-down list, a dialog box, and a control mechanism (for example, the CPU of the terminal device) that corresponds to the GUI. In addition, the GUI is standardized in various new type application programs, that is, a same operation is always completed in a same manner. For example, operating any graphical option (referred to as option in the following) in the text form or the icon form in the GUI may be clicking the option by the user by using the mouse.

The following describes the display screen of the email box in this embodiment of the present invention by using an example.

Referring to FIG. 3. FIG. 3 is a schematic diagram of an instance of a display screen of an email box according to an embodiment of the present invention. As shown in FIG. 3, the display screen of the email box may be a display screen of an email box of a PC or a portable computer. The display screen of the email box may include a plurality of areas, and the areas have different functions. For example, the display screen of the email box shown in FIG. 3 mainly includes a menu bar 31, a toolbar 32, an email folder area 33, a title bar 34, an email list area 35, an email preview area 36, and an email search area 37.

The menu bar 31 may include options of “file (F)”. “edit (E)”, “view V”, “go G”, “tool T”, “action A”, and “help H”. The terminal device may receive a click operation instruction of a user for each option in the menu bar 31, to set the email box or an email in the email box. The toolbar 32 may include options of “create”, “print”, “delete”, “mark”. “reply to all”, “reply”, “forward”, and “send/receive”. The terminal device may receive a click operation instruction of the user for each option in the toolbar 32, to process the email in the email box. For example, the terminal device may receive a click operation instruction of the user for “reply” in the toolbar 32, to reply to a selected email in the email box. The email folder area 33 may include options of a favorites folder 331 and an email folder 332. The email favorites folder 331 may include options of “inbox”, “unread”, “email marked with subsequent mark”, and “sent”, and the favorites folder 331 may be used to store an email collected by the user. For example, the “inbox” in the favorites folder 331 may be used to store an email collected by the user from the emails received in the email box. The email folder 332 includes options of an email box 3321 and a search folder 3322. The email box 3321 may include options of “draft”, “outbox”, “spam”, “inbox”, “sent”, and “deleted”. The options in the email box 3321 may be used to store an email sent from or received in the email box. For example, the “inbox” in the email box 3321 may be used to store an email received in the email box. The title bar 34 may include options such as “sender”, “subject”, and “time”, and the options may be used to set a display manner of the email in the email box. The email list area 35 may be used to display the email sent from or received in the email box. For example, after receiving a click operation instruction of the user for the “inbox” in the email box 3321, the terminal device may display the email received in the email box in the email list area 35. The email preview area 36 may be used to display a selected email in the emails displayed in the email list area 35, for example, display email information such as an email address of a sender, an email address of a recipient, an email address of a carbon copy, email sending time, and an email body that are of the selected email. The email search area 37 includes options of “input box” and “confirm”. The terminal device may receive a character entered by the user into the input box of the search area 37, receive a click operation instruction of the user for the option “confirm” in the search area 37, and search, in the email box, an email that corresponds to the character entered into the input box.

It should be noted that, either the PC or the portable computer includes an input unit, and the input unit may be a mouse and a keyboard. The “click operation instruction of the user for the option” may be that the user operates the mouse to click the option. For example, an arrow shown in FIG. 3 is used to indicate a position of a cursor of the mouse on the display screen. The user may enter a character into the input box in the email search area 37 by using the keyboard, and the keyboard may be a hardware device constituted by a group of button switches assembled in an array manner.

When receiving a click operation instruction of the user for any option on the display screen of the email box of the terminal device, the terminal device may display the option in a highlighted manner. For example, as shown in FIG. 3, when receiving a click operation instruction of the user for the “inbox” in the email box 3321, the terminal device may display the “inbox” option in a highlighted manner when displaying the display screen of the email box.

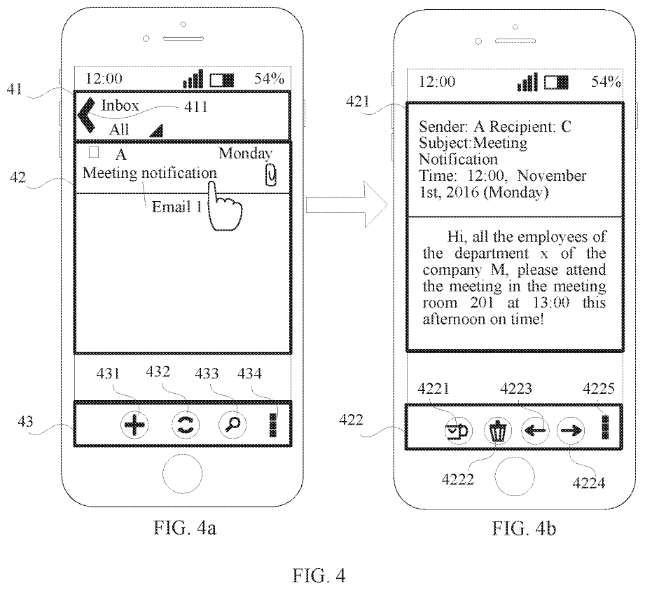

Referring to FIG. 4. FIG. 4 is a schematic diagram of another instance of a display screen of an email box according to an embodiment of the present invention. As shown in FIG. 4, the display screen of the email box may be a display screen of an email box of a mobile phone. The display screen of the email box may include a plurality of areas, and the areas have different functions. For example, the display screen of the email box in FIG. 4a may include an email folder area 41, an email list area 42, and a toolbar 43.

The email folder area 41 may include an icon 411. After the terminal device receives a click operation instruction of the user for the icon 411, the terminal device may display options of “draft”, “outbox”, “spam”, “inbox”, “sent”, and “deleted” on the display screen of the email box of the terminal device. The options of “draft”, “outbox”, “spam”, “inbox”, “sent”, and “deleted” may respectively correspond to a draft email, a sent email, a spam, a received email, and a deleted email that are stored in the email box of the terminal device. For example, after receiving the click operation instruction of the user for the icon 411 and receiving a click operation instruction of the user for the “inbox”, the terminal device may display, on the display screen of the email box of the terminal device, an email received in the email box.

The email list area 42 shown in FIG. 4a may be used to display the email sent from or received in the email box. For example, after receiving the click operation instruction of the user for the icon 411 and receiving the click operation instruction of the user for the option “inbox”, the terminal device may display, in the email list area 42, the email received in the email box. The toolbar 43 may include a creation icon 431, a refresh icon 432, a search icon 433, and a setting icon 434. The creation icon 431 may be used to create an email by the terminal device by using the email box. The icon 432 may be used by the terminal device to refresh content displayed on the display screen of the email box. The icon 433 may be used by the terminal device to search for the email in the email box. The setting icon 434 may be used by the terminal device to set the email box.

It should be noted that, the foregoing mobile phone includes a mobile phone screen, the mobile phone screen may be used as a touch panel, and the user may perform a click operation on the touch panel by using a finger. Then, the mobile phone may receive a corresponding click operation instruction. In addition, the mobile phone screen may further be used as a display panel, and the display panel may be used to display the display screen of the email box of the mobile phone. A “hand icon” in FIG. 4a is used to schematically represent a hand. The “hand icon” is used only to indicate a position of a finger of the user in this embodiment of the present invention. During actual application, however, the “hand icon” is not displayed on the mobile phone screen. FIG. 4a indicates, by using the position of the “hand icon”, a click operation performed by the user on an option.

For example, as shown in FIG. 4a, after receiving a click operation instruction of the user for an email 1 in the email list area 42, the terminal device may switch the display screen of the email box from the display screen shown in FIG. 4a to a display screen shown in FIG. 4b. As shown in FIG. 4b, the display screen of the email box may further include an email preview area 421 and a menu bar 422. Specifically, for descriptions of the email preview area 421, refer to related descriptions of the email preview area 36 in FIG. 3; and for descriptions of the menu bar 422, refer to related descriptions of the menu bar 31 in FIG. 3. These are not described in detail again in this embodiment of the present invention.

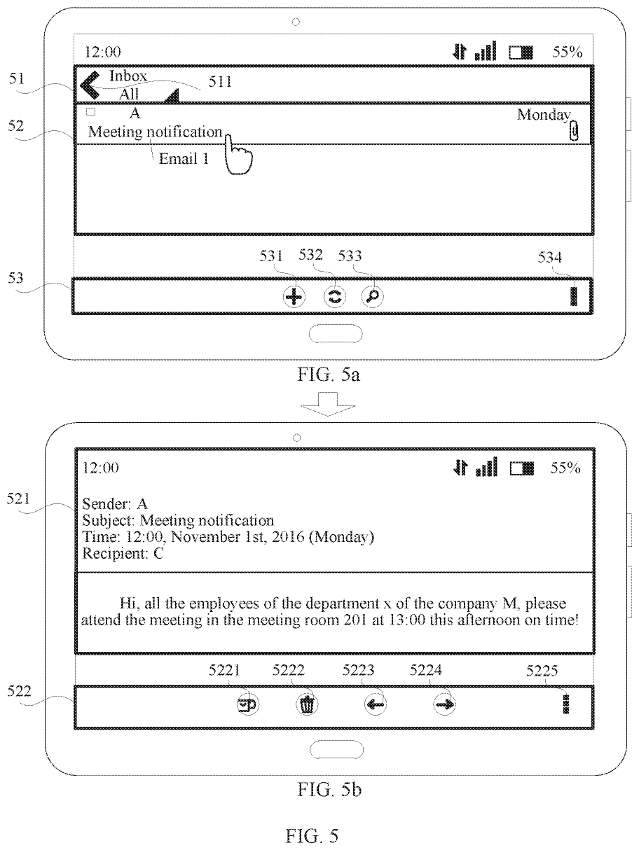

Referring to FIG. 5, FIG. 5 is a schematic diagram of another instance of a display screen of an email box according to an embodiment of the present invention. As shown in FIG. 5, the display screen of the email box may be a display screen of an email box of a tablet computer. The display screen of the email box may include a plurality of areas, and the areas have different functions. For example, the display screen of the email box in FIG. 5 may include an email folder area 51, an email list area 52, and a toolbar 53. For descriptions of the email folder area 51, the email list area 52, and the toolbar 53 that are included on the display screen of the email box in this embodiment of the present invention, refer to the descriptions of the email folder area 41, the email list area 42, and the toolbar 43 in FIG. 4, and details are not described again in this embodiment of the present invention.

For example, a scenario in which an employee C of a company M receives and sends an email by using an email box is used as an example in this embodiment of the present invention, and that email grouping is performed on emails in the email box of the employee C by using an email grouping method provided in this embodiment of the present invention is used as an example, to describe the email grouping method provided in this embodiment of the present invention by using an example.

To notify an employee B, the employee C, and an employee D of a department x of the company of attending a meeting in a meeting room 201 at 13:00 this afternoon, an employee A of the company M may send an email 1 to email boxes of the employee B, the employee C, and the employee D of the company. An email subject of the email 1 is “meeting notification”, and an email body of the email 1 is “hi, all the employees of the department x, please attend the meeting in the meeting room 201 at 13:00 this afternoon on time!”.

After receiving the email 1 in the email box, the employee C may reply to the email box of the employee A of the department x in response to the email 1 by using the email box in a terminal device of the employee C, that is, send an email 2 to the employee A of the department x. An email subject of the email 2 is “reply: meeting notification”, and an email body of the email 2 includes “got it! I will attend the meeting at 13:00 this afternoon on time!”.

After receiving the email 1 in the email box, the employee C may further forward the email 1 to an employee E of the department x by using the email box of a terminal device of the employee C, that is, send an email 3 to an email box of the employee E of the department x. An email subject of the email 3 is “forward: meeting notification//thank you!”, and an email body of the email 3 includes “hi, please take the meeting materials to attend the meeting at 13:00 this afternoon, and please reply if you receive the email, thank you!”.

If the employee C sets a receipt-requesting function for the email 3 before sending the email 3 to the email box of the employee E by using the email box of the terminal device of the employee C, that is, when the employee E checks the email 3 in the email box of the employee E, a display screen of the email box of the employee E may prompt the employee E to trigger the email box of the employee E to reply to the email box of the employee C with a receipt, after the employee E triggers the email box of the employee E to reply to the email box of the employee C with the receipt, the email box of the employee C may receive an email 4. An email subject of the email 4 is “read: forward: meeting notification//thank you!”, and an email body of the email 4 includes “read time: 12:04, Nov. 1, 2016 (Monday)”.

After receiving, by using the email box of the employee E, the email 3 sent by the employee C by using the email box of the employee C, the employee E may send, by using the email box of the employee E, an email 5 to the email box of the employee C. An email subject of the email 5 is “OK. I will take the meeting materials”, and an email body of the email 5 includes all the content of the email 3.

To notify the employee B of the department x of the company of signing up for a singing competition, the employee C may send an email 6 to the email box of the employee B by using the email box of the terminal device of the employee C. An email subject of the email 6 is “competition notification”, and an email body of the email 6 is “hi, the entry for signing up for the singing competition is started now. If you need to sign up for the competition, you can reply to the email, thank you!”

The email box of the employee C may further receive an email replied by the employee B to the email 6 by using the email box of the terminal device of the employee B, that is, an email box of the employee D receives an email 7. An email subject of the email 7 is “reply: competition notification”, and an email body of the email 7 is “hi, I sign up for the singing competition!”

For example, the following shows, in a manner of a list, email subjects of emails received or sent by the employee C in the foregoing scenarios. As shown in Table 1. Table 1 is a schematic diagram of an email information list according to an embodiment of the present invention:

TABLE 1
Email information list

| Email | Sender | Recipient | Sending time | Email subject |
|---|---|---|---|---|
| Email 1 | A | C | 12:00 | Meeting notification |
| Email 2 | C | A | 12:01 | Reply: Meeting notification |
| Email 3 | C | E | 12:02 | Forward: Meeting notification//Thank you! |
| Email 4 | E | C | 12:04 | Read: Forward: Meeting notification//Thank you! |
| Email 5 | E | C | 12:05 | OK, I will take the meeting materials |
| Email 6 | C | B | 12:08 | Competition notification |
| Email 7 | B | C | 12:09 | Reply: Competition notification |

Examples are used in the following to describe a “default character” and a “non-default character” in this embodiment of the present invention.

The default character may be a character that is automatically added into an email subject of an email in an email box in a process of receiving and sending the email. For example, “reply:”, “re:”, “forward:”, “read:”, “RE:”, “FW:”. “read:” are all default characters. The non-default character may be a character that is manually added by a user into the email subject of the email other than the foregoing default characters in the process of receiving and sending the email. The non-default character may be manually added by the user into any position of the email subject of the email. [0098]1 For example, the “reply:” in the email subject of the email 2, the “forward:” in the email subject of the email 3, the “read:” and “forward:” in the email subject of the email 4, and the “reply:” in the email subject of the email 7 that are shown in Table 1 are all the default characters; and the “i/thank you!” in the email subjects of the email 3 and the email 4, and the “OK, I will take the meeting materials” in the email subject of the email 5 are the non-default characters.

To resolve a problem in the prior art that email grouping performed in an email box cannot achieve an expected effect, an embodiment of the present invention provides two email grouping modes: an “initial subject mode” and a “keyword mode” based on an existing email grouping mode (that is, a “conventional grouping mode”).

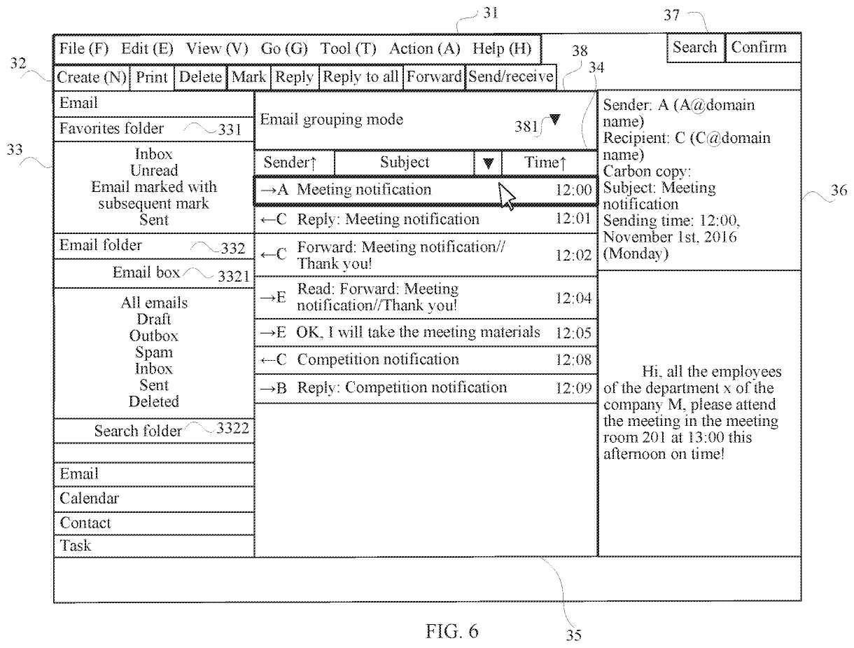

For example, based on the scenario in which the employee C of the company M receives and sends the email by using the email box, as shown in any accompanying drawings of FIG. 6 to FIG. 8, FIG. 6 to FIG. 8 are schematic diagrams of an instance of a display screen of an email box according to an embodiment of the present invention.

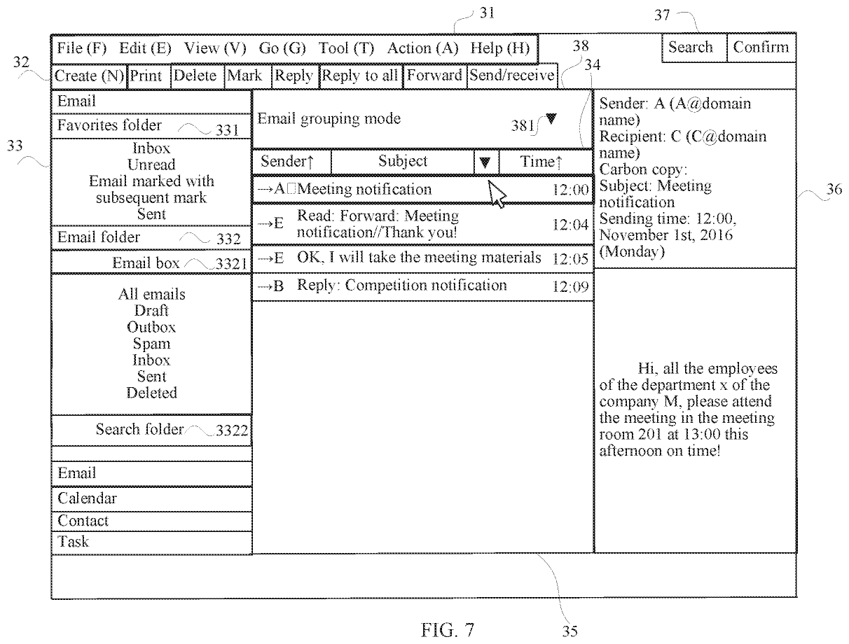

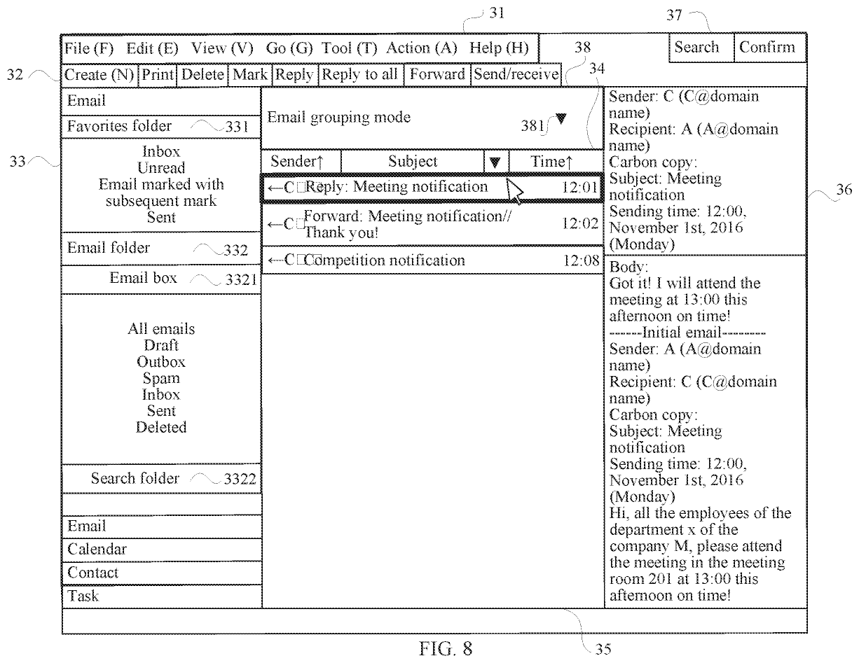

When receiving a click operation instruction of a user for “all emails” in an email box 3321 on the display screen of the email box, the terminal device may display the display screen of the email box shown in FIG. 6. When receiving a click operation instruction of the user for “inbox” in the email box 3321 on the display screen of the email box, the terminal device may display the display screen of the email box shown in FIG. 7. When receiving a click operation instruction of the user for “outbox” in the email box 3321 on the display screen of the email box, the terminal device may display the display screen of the email box shown in FIG. 8.

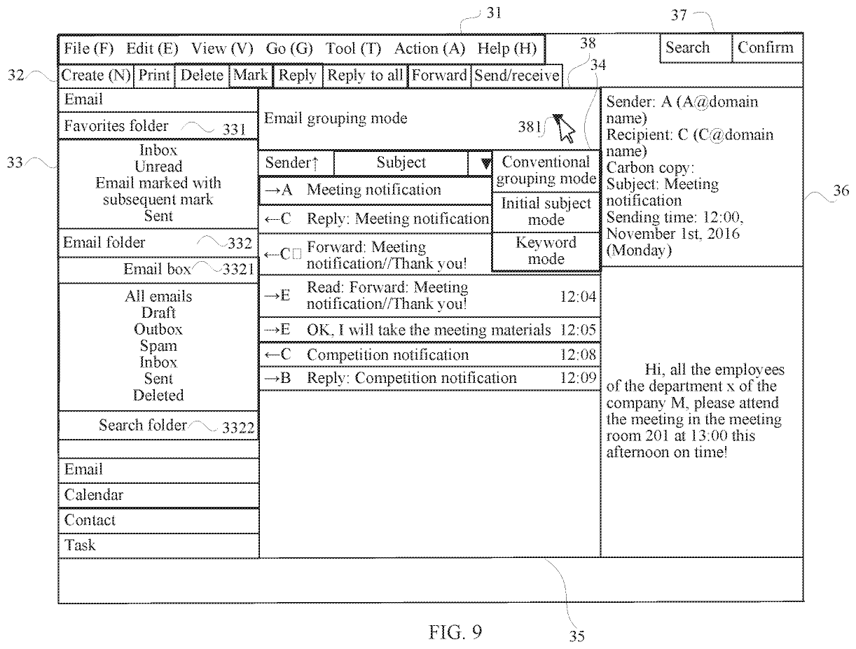

As shown in any accompanying drawings of FIG. 6 to FIG. 8, the display screen of the email box provided in this embodiment of the present invention may further include an email grouping bar 38, and the email grouping bar 38 includes a drop-down window option 381. Using the display screen of the email box shown in FIG. 6 as an example, when the terminal device displays the display screen of the email box shown in FIG. 6, if a click operation is performed by the user on the drop-down window option 381 on the display screen of the email box shown in FIG. 6, the terminal device may display a display screen of an email box shown in FIG. 9.

As shown in FIG. 9, a drop-down window corresponding to the drop-down window option 381 is displayed through extension, and the drop-down window includes the following three mode options: a “conventional grouping mode”, an “initial subject mode”, and a “keyword mode”.

In the “conventional grouping mode”, the terminal device may group, by using a prior-art method, emails in an email list area 35 shown in FIG. 9.

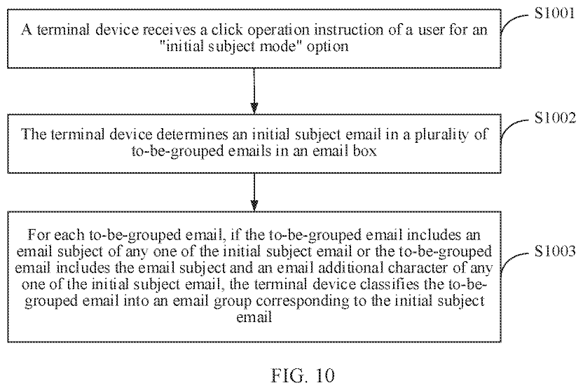

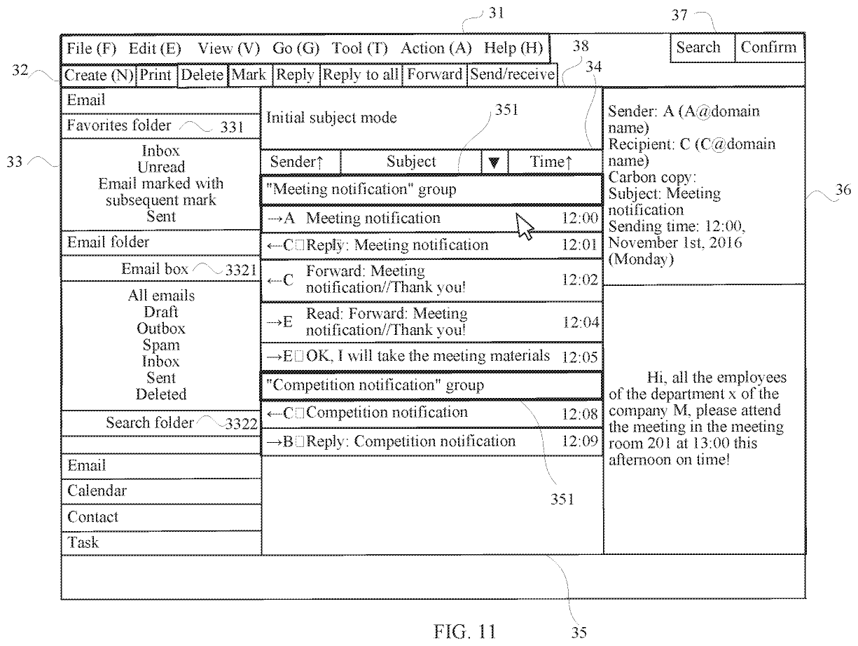

In the “initial subject mode”, the terminal device may group, by using an email grouping method provided in this embodiment of the present invention, the emails in the email list area 35 shown in FIG. 9, that is, group, by using an email grouping method shown in FIG. 10, the emails in the email list area 35 shown in FIG. 9, and display a display screen of an email box shown in FIG. 11 after the grouping. Specifically, as shown in FIG. 10, the email grouping method provided in this embodiment of the present invention may include S1001 to S1003.

S1001. A terminal device receives a click operation instruction of a user for the “initial subject mode” option.

S1002. The terminal device determines an initial subject email in a plurality of to-be-grouped emails in an email box.

In this embodiment of the present invention, the email subject of the initial subject email is included in another email, and the initial subject email does not include an email subject of the another email. Specifically, the email subject of the initial subject email is included in an email subject or an email body of the another email, and neither the email subject nor an email body of the initial subject email includes the email subject of the another email.

For example, in the seven to-be-grouped emails shown in FIG. 9 or Table 1, the email subject “meeting notification” of the email 1 is included in the email subject and the email body of the email 2, the email subject “meeting notification” of the email 1 is included in the email subject and the email body of the email 3, the email subject “meeting notification” of the email 1 is included in the email subject and the email body of the email 4, the email subject “meeting notification” of the email 1 is included in the email body of the email 5: and neither the email subject nor the email body of the email 1 includes the email subject of any one of the email 2, the email 3, the email 4, and the email 5. Therefore, the terminal device may determine that the email 1 is an initial subject email (denoted as an initial subject email 1).

Because the email subject “competition notification” of the email 6 shown in FIG. 9 or Table 1 is included in the email subject and the email body of the email 7, and neither the email subject nor the email body of the email 6 includes the email subject of the email 7, the terminal device may determine that the email 6 is an initial subject email (denoted as an initial subject email 2).

It should be emphasized that, in an email receiving and sending process, when the user performs an operation such as replying to or forwarding an initial subject email, the user may modify an email subject of the “replied or forwarded email”, so that the email subject of the replied or forwarded email does not include an email subject corresponding to the initial subject email. For example, as shown in Table 1, although the email 5 is an email replied by the user based on the email 1, the email subject “OK. I will take the meeting materials” of the email 5 does not include the email subject “meeting notification” of the email 1. For this case, although the email subject of the email 5 does not include the email subject of the email 1, because the email 5 is the email replied to the email 1, the email body of the email 5 includes the email subject of the email 1. As a result, it cannot be determined that the email 5 is an initial subject email.

S1003. For each to-be-grouped email, if the to-be-grouped email includes an email subject of any one of the initial subject email or the to-be-grouped email includes the email subject and an email additional character of any one of the initial subject email, the terminal device classifies the to-be-grouped email into an email group corresponding to the initial subject email.

The email additional character may include at least one of a default character and a non-default character, and each initial subject email corresponds to one email group.

For example, when an email subject or an email body of a to-be-grouped email includes an email subject of any initial subject email, or when the email subject or the email body of the to-be-grouped email includes the email subject or an email additional character of any initial subject email, the terminal device may classify the to-be-grouped email into an email group corresponding to the initial subject email.

For example, the email 1 to the email 7 shown in FIG. 9 or Table 1 are used as an example. Because the email subject “reply: meeting notification” of the email 2 includes the email subject “meeting notification” of the initial subject email 1 (the email 1), the terminal device may classify the email 2 in the email group corresponding to the initial subject email 1. Likewise, the terminal device may further classify the email 3 and the email 4 in the email group corresponding to the initial subject email 1. In addition, because the email body of the email 5 includes the email subject “meeting notification” of the initial subject email 1 (the email 1), the terminal device may classify the email 5 in the email group corresponding to the initial subject email 1 (denoted as a “meeting notification” group).

Because the email 7 includes the email subject “competition notification” of the initial subject email 2 (the email 6), the terminal device may classify the email 7 in the email group corresponding to the initial subject email 2 (denoted as a “competition notification” group).

For example, as shown in FIG. 11, the email list area 35 on the display screen of the email provided in FIG. 11 in this embodiment of the present invention may further include one or more group title bars 351. The email list area 35 shown in FIG. 11 includes a group title bar 351 corresponding to the “meeting notification” group and a group title bar 351 corresponding to the “competition notification” group.

In the email grouping method provided in this embodiment of the present invention, the initial subject email may be determined in the plurality of to-be-grouped emails in the email box. The email subject of the initial subject email is included in the another email in the plurality of to-be-grouped emails, and the initial subject email does not include the email subject of the another email, that is, the initial subject email in this solution may be an email whose email subject does not include the default character (such as “reply:” and “RE”) and the non-default character (that is, in an email receiving and sending process, a character or a text character that is manually added by the user into an email subject of an email other than the default character). Therefore, for the email group to which the initial subject email belongs, regardless of whether the reply character included in the email subject of the to-be-grouped email is the default character or the non-default character, provided that the to-be-grouped email includes the email subject of the initial subject email, the to-be-grouped email may be classified into the email group. In this way, a problem in the prior art that grouping performed on a plurality of to-be-grouped emails in an email box cannot achieve an expected effect may be resolved.

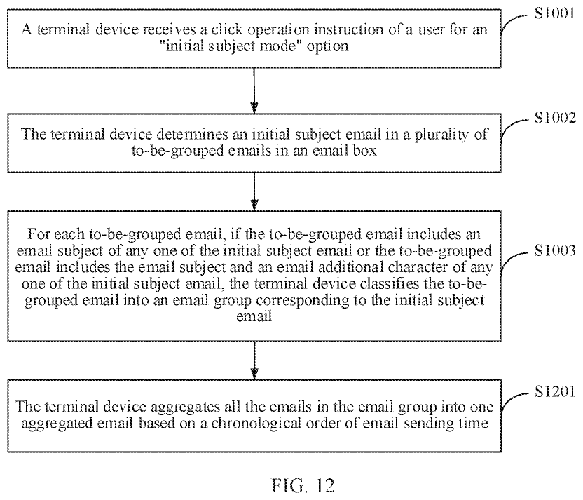

Further, after the emails in the email box are grouped, because all the emails included in the email group include the email subject of the initial subject email corresponding to the email group, for example, all of the email 1, the email 2, the email 3, the email 4, and the email 5 that are included in the “meeting notification” group include the email subject of the initial subject email 1 (the email 1), that is, all emails in the “meeting notification” group are emails based on the email subject “meeting notification” (the email subject of the initial subject email 1), to facilitate check of the emails in the email group by the user, as shown in FIG. 12, after S1003 shown in FIG. 10, the method in this embodiment of the present invention may further include S1201.

S1201. The terminal device aggregates all the emails in the email group into one aggregated email based on a chronological order of email sending time.

The aggregated email corresponding to each email group includes information about all the emails in the email group.

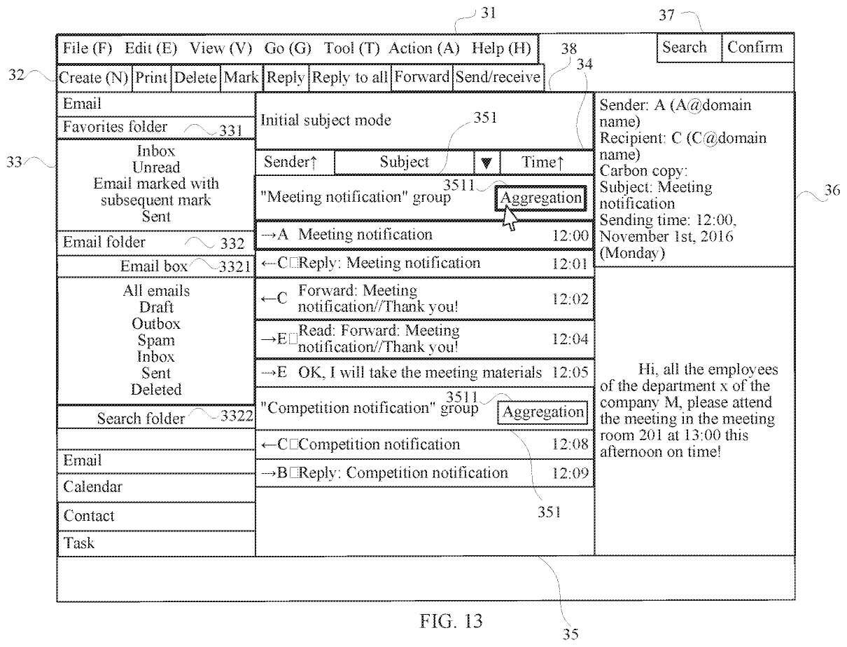

For example, referring to FIG. 13. FIG. 13 is a schematic diagram of an instance of a display screen of another email box according to an embodiment of the present invention. As shown in FIG. 13, a title bar of each email group includes an “aggregation” option. After receiving a click operation instruction of the user for the “aggregation” option, the terminal device may perform S1201, to aggregate emails in an email group corresponding to the aggregation button into one aggregated email.

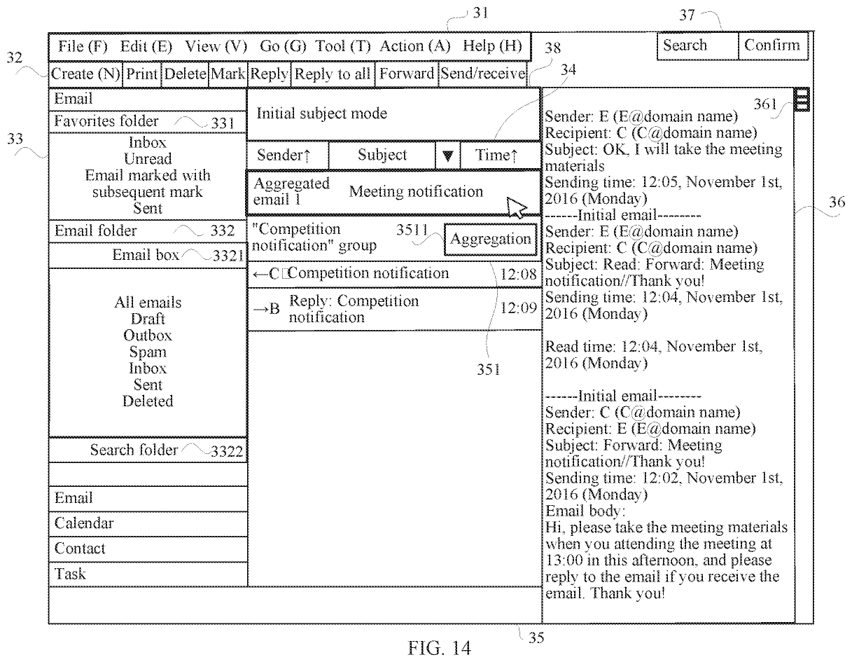

For example, it is assumed that after receiving the click operation instruction of the user for the “aggregation” option 3511 of the “meeting notification” group, the terminal device may aggregate the emails in the “meeting notification” group that corresponds to the “aggregation” option 3511 into one aggregated email, and may generate and display a display screen of an email box shown in FIG. 14.

Specifically, the terminal device may aggregate the emails in the “meeting notification” group (the email group to which the initial subject email 1 belongs) into one aggregated email (denoted as an aggregated email 1) based on a chronological order of email sending time, and the aggregated email 1 includes information about all the emails in the “meeting notification” group. On the display screen of the email box shown in FIG. 14, the email preview area 36 displays the aggregated email 1 corresponding to the “meeting notification” group.

The display screen of the email box shown in FIG. 14 may further include a “sliding” option 361. After receiving a sliding operation instruction of the user for the “sliding” option 361, the terminal device may update email information displayed in the email preview area 36. The sliding operation instruction may be an instruction generated after the terminal device detects that the user remains in a state of clicking the mouse in a specific period and drags a cursor of the mouse to move.

Likewise, the terminal device may aggregate, based on a chronological order of email sending time of the emails (the email 6 and the email 7) in the email group to which the initial subject email 2 belongs, the emails in the email group (the “competition notification” group) to which the initial subject email 2 belongs into one aggregated email (denoted as an aggregated email 2).

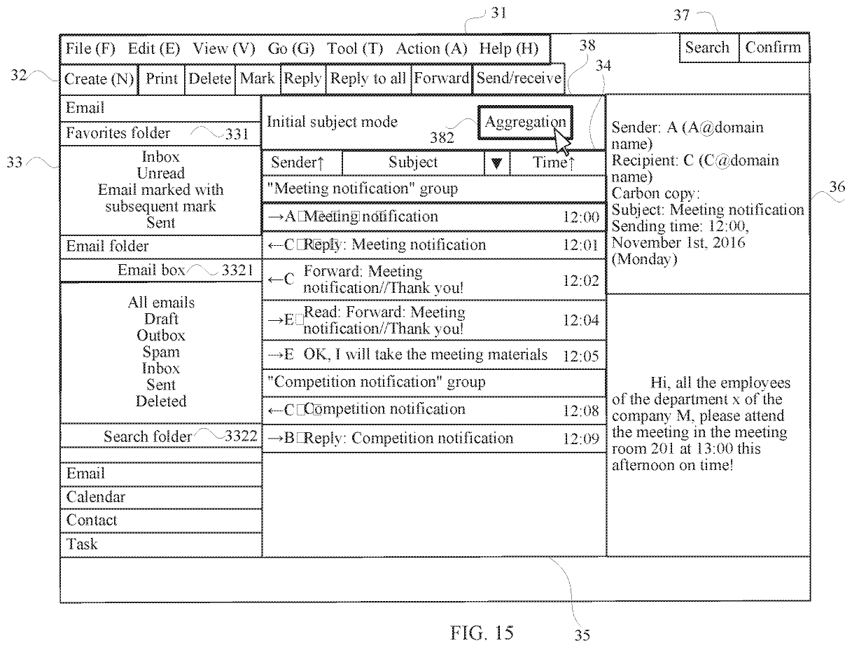

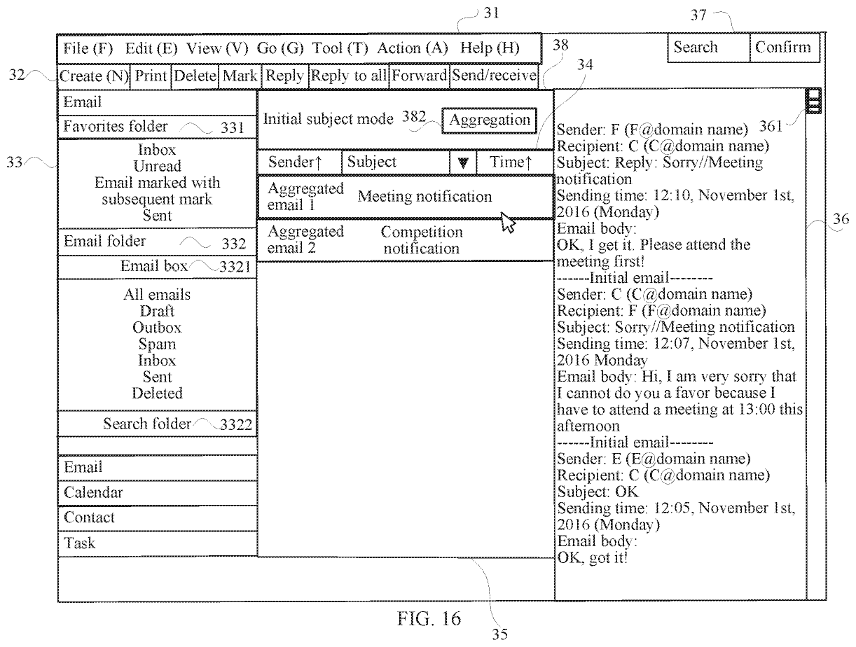

Further, as shown FIG. 15, FIG. 15 is a schematic diagram of an instance of a display screen of another email box according to an embodiment of the present invention. An email grouping bar 38 of the display screen of the email box shown in FIG. 15 may further include an “aggregation” option 382. The “aggregation” option 382 is used to control over aggregation of the emails in the email group by the terminal device in a unified manner. After receiving a click operation instruction of the user for the “aggregation” option 382, the terminal device may perform S1201 to aggregate emails in each email group shown in FIG. 15, and generate and display a display screen of an email box shown in FIG. 16. The aggregated email 1 shown in FIG. 16 is an aggregated email obtained by aggregating all the emails in the “meeting notification” group by the terminal device, and the aggregated email 2 is an aggregated email obtained by aggregating all the emails in the “competition notification” group by the terminal device.

In the email grouping method in this embodiment of the present invention, all the emails in each email group may be aggregated into one aggregated email based on a chronological order of email sending time, and all the emails in the aggregated email are based on one email subject (the email subject of the initial subject email). In this way, after all emails in one email group are aggregated into one aggregated email based on a chronological order of email sending time, the user may conveniently check all the emails in the email group based on a chronological order of email sending time.

Further, in a process of performing email grouping, a new email may be received in or a new email may be sent from the email box. In the method in this embodiment of the present invention, when the new email received in or the new email sent from the email box is received, it may further be determined that the new email includes the email subject of the initial subject email, and the new email is classified into the email group to which the initial subject email belongs. Specifically, after S1003, the email grouping method in this embodiment of the present invention may further include: after the terminal device receives the new email received in the email box or the new email sent from the email box, if the new email includes the email subject of the initial subject email, classifying, by the terminal device, the new email in the email group corresponding to the initial subject email; or if the new email does not include the email subject of the initial subject email, using, by the terminal device, the new email as a new initial subject email.

Further, after classifying the new email into the corresponding email group, the terminal device may further re-aggregate the new email with the aggregated email corresponding to the email group to which the new email belongs, to obtain a new aggregated email. Specifically, after the terminal device classifies the new email into the email group corresponding to the initial subject email, the method in this embodiment of the present invention may further include: aggregating, by the terminal device based on a chronological order of email sending time, the new email and the aggregated email corresponding to the email group to which the new email belongs into a new aggregated email. The new aggregated email includes information about the new email and information about the aggregated email.

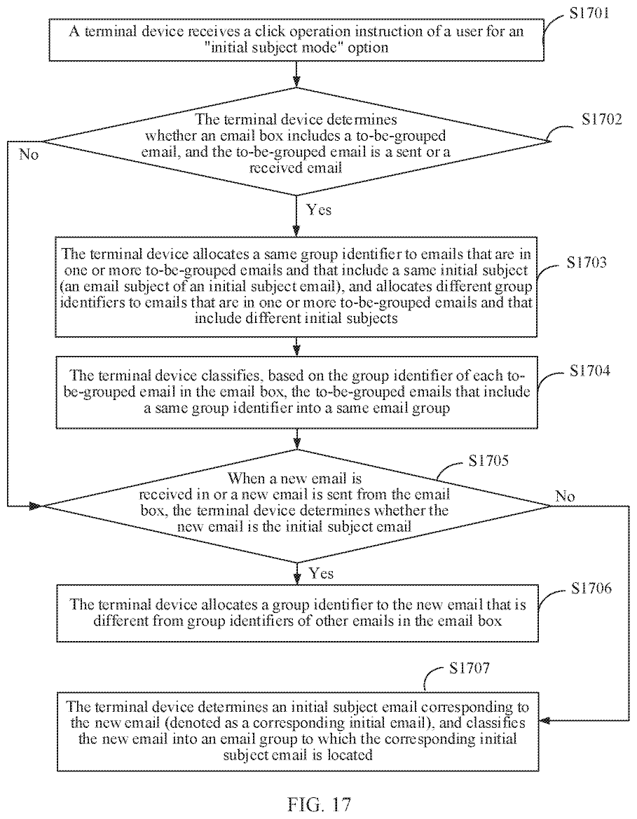

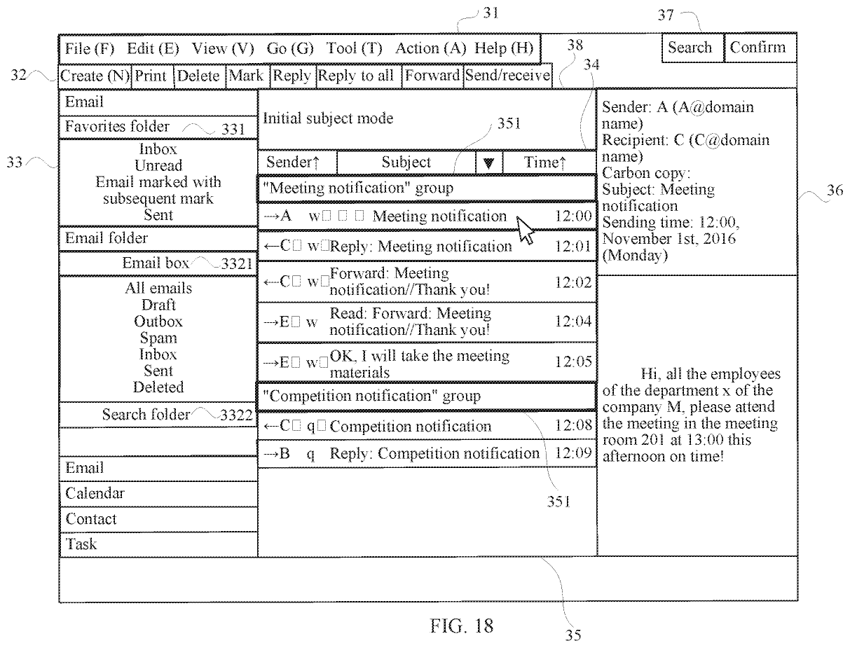

In another embodiment of the present invention, in the “initial subject mode”, the terminal device may group, by using an email grouping method provided in this embodiment of the present invention, the emails in the email list area 35 shown in FIG. 9, that is, group, by using an email grouping method shown in FIG. 17, the emails in the email list area 35 shown in FIG. 9, and display a display screen of an email box shown in FIG. 18 after the grouping. Specifically, as shown in FIG. 17, the email grouping method provided in this embodiment of the present invention may include S1701 to S1704.

S1701. A terminal device receives a click operation instruction of a user for the “initial subject mode” option.

S1702. The terminal device determines whether an email box includes a to-be-grouped email, and the to-be-grouped email is a sent or a received email.

Specifically, if the email box includes one or more to-be-grouped emails, S1703 is performed; or if the email box does not include the to-be-grouped email, S1705 is performed.

S1703. The terminal device allocates a same group identifier to emails that are in one or more to-be-grouped emails and that include a same initial subject (an email subject of an initial subject email), and allocates different group identifiers to emails that are in one or more to-be-grouped emails and that include different initial subjects.

For example, the email 1 to the email 7 shown in FIG. 9 or Table 1 are used as an example. Because all of the email 1, the email 2, the email 3, the email 4, and the email 5 include the email subject “meeting notification” (initial subject 1) of the email 1 (the initial subject email 1), the terminal device may allocate a same group identifier (a group identifier 1) to the email 1, the email 2, the email 2, the email 4, and the email 5, for example, the group identifier 1 is “w”.

Because both the email 6 and the email 7 include the email subject “competition notification” (an initial subject 2) of the email 6 (denoted as the initial subject email 2), the terminal device may allocate a same group identifier (a group identifier 2) to the email 6 and the email 7, for example, the group identifier 2 is “q”. Apparently, the group identifier 1 (“w”) corresponding to the initial subject 1 is different from the group identifier 2 (“q”) corresponding to the initial subject 2.

S1704. The terminal device classifies, based on the group identifier of each to-be-grouped email in the email box, the to-be-grouped emails that include a same group identifier into a same email group.

Because the group identifier allocated by the terminal device to the emails that are in the one or more to-be-grouped emails and that include a same initial subject is the same, the terminal device classifies the to-be-grouped emails including the same group identifier into a same email group, so that a plurality of to-be-grouped emails based on a same initial subject in an email box that are sent or received may be classified into a same email group.

For example, the terminal device may classify the email 1, the email 2, the email 2, the email 4, and the email 5 that include the group identifier 1 (“w”) into a same email group (denoted as the “meeting notification group”), and the terminal device may classify the email 6 and the email 7 that include the group identifier 2 (“q”) into a same email group (denoted as the “competition notification group”).

As shown in FIG. 18, an email list area 35 of a display screen of an email provided in this embodiment of the present invention in FIG. 18 may include the group title bar 351 corresponding to the “meeting notification group” and the group title bar 351 corresponding to the “competition notification group”. In addition, all of the email 1 to the email 5 in the “meeting notification group” displayed in the email list area 35 in FIG. 18 include the group identifier 1 (“w”), and both the email 6 and the email 7 in the displayed “competition notification group” include the group identifier 2 (“q”).

Further, in the process of performing the email grouping, a new email may be received in or a new email may be sent from the email box. Based on this, as shown in FIG. 17, the method in this embodiment of the present invention may further include S1705 to S1707.

S1705. When a new email is received in or a new email is sent from the email box, the terminal device determines whether the new email is the initial subject email.

The terminal device may determine, based on an email subject of the new email, whether the new email is the initial subject email. For a method in which the terminal device determines, based on the email subject of the new email, whether the new email is the initial subject email, refer to related descriptions in S1002 in the foregoing embodiment, and details are not described herein again.

Alternatively, in an implementation, when the terminal device sends a new email by using the email box, the terminal device may determine, based on a click operation performed by the user for triggering of writing the new email on the display screen of the email box, whether the new email is the initial subject email. For example, if the writing of the new email is triggered after the terminal device receives a click operation instruction of the user for a “create” option in the toolbar 32 on the display screen of the email box, the terminal device may determine that the new email is the initial subject email; or if the writing of the new email is triggered after the terminal device receives an email in the email box and receives, based on the email, a click operation instruction of the user for a “reply” option or a “forward” option on the display screen of the email box in the toolbar 32, the terminal device may determine that the new email is not the initial subject email.

For example, based on the scenario in which the employee C of the company M receives and sends an email by using the email box, it is assumed that currently, to notify an employee F of the department x of the company of signing up for in a sports meeting, the employee C may send an email 8 to an email box of the employee F by using the email box of the terminal device of the employee C. An email subject of the email 8 is “sports meeting notification”, and an email body of the email 8 is “hi, the entry for signing up for the spring sports meeting of the company this year is started now. Please reply to the email if you receive the email, thank you!”

For example, an email subject of the new email (the email 8) sent by the employee C to the email box of the employee F by using the email box of the terminal device is the “sports meeting notification”, however, none of the email 1 to the email 7 that currently exist in the email box includes the email subject (the “sports meeting notification”) of the email 8 and the email 8 does not include the email subject of any one of the email 1 to the email 7. Therefore, the terminal device may determine that the email 8 is the initial subject email (denoted as an initial subject email 3). Alternatively, because the writing of the new email (the email 8) may be triggered after the terminal device receives the click operation instruction for the “create” option in the toolbar 32 on the display screen of the email box of the employee C, the terminal device may determine, when sending the email 8 by using the email box, that the email 8 is the initial subject email (the initial subject email 3).

After the employee C sends the email 8 to the email box of the employee F by using the email box of the terminal device of the employee C, emails that already exist in the email box of the employee C include the email 1 to the email 8. Then, it is assumed that a reply to the email 8 by the employee F by using the email box of the employee F may be received in the email box of the employee C, that is, an email 9 may be received in the email box of the employee C. An email subject of the email 9 is “reply: sports meeting notification”, and an email body of the email 9 is “hi, I will not take part in the sports meeting this year, thank you!”

When the employee C receives, by using the email box of the terminal device, the new email (the email 9) sent by the employee F by using the email box, because the email 9 includes the email subject (the “sports meeting notification”) of the email 8, and none of the email 1 to the email 8 includes the email subject (reply: sports meeting notification) of the email 9, the terminal device may determine that the email 9 is not an initial subject email.

Specifically, if the new email received by the terminal device in the email box or sent by the terminal device from the email box is an initial subject email, the email grouping method provided in this embodiment of the present invention proceeds to S1706; or if the new email is not an initial subject email, the email grouping method proceeds to S1707.

S1706. The terminal device allocates a group identifier to the new email that is different from group identifiers of other emails in the email box.

For example, after determining that the email 8 is the initial subject email (the initial subject email 3), the terminal device may allocate a group identifier (denoted as a group identifier 3) to the email 8, and the group identifier 3 may be “v”. Apparently, the group identifier 3 (“v”) is different from the group identifier 1 (“w”) of the “meeting notification” group or the group identifier 2 (“q”) of the “competition notification” group.

Further, the terminal device may classify the email 8 in the email group (denoted as the “sports meeting notification” group) in which the initial subject email 3 is located, that is, the terminal device classifies the email 8 in a new email group.

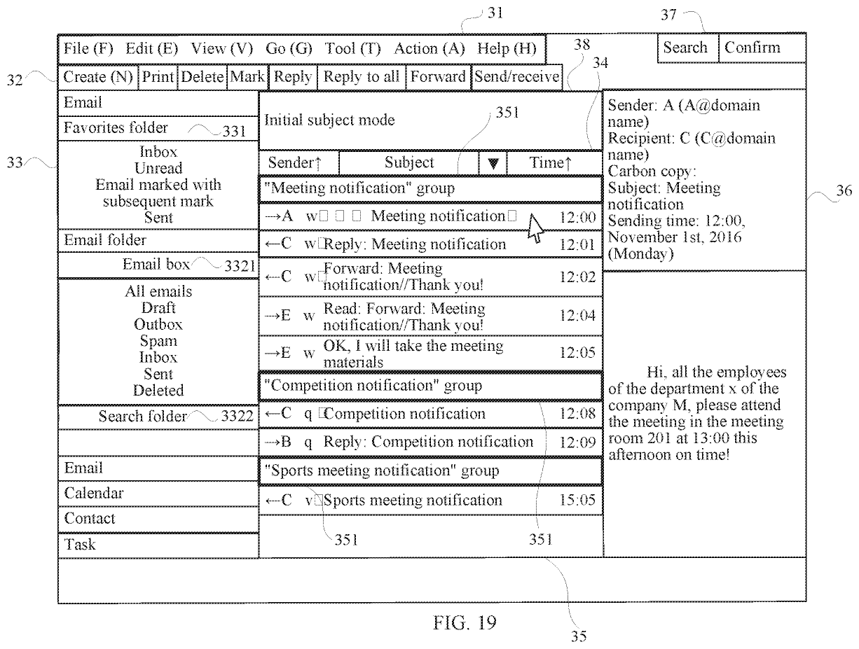

For example, based on the email grouping result of the display screen of the email box shown in FIG. 18, after the new email (the email 8) is grouped by using the email grouping method in FIG. 17, the terminal device may display a display screen of an email box shown in FIG. 19. As shown in FIG. 19, an email list area 35 on the display screen in the email may further include a group title bar 351 corresponding to the “sports meeting notification” group. In addition, the email 8 in the “meeting notification” group displayed in the email list area 35 in FIG. 19 includes the group identifier 3 (“v”).

S1707. The terminal device determines an initial subject email corresponding to the new email (denoted as a corresponding initial email), and classifies the new email in an email group to which the corresponding initial subject email is located.

For example, after determining that the email 9 is not the initial subject email, the terminal device may determine that the initial subject email corresponding to the email 9 is the email 8 (the initial subject email 3), and may classify the email 9 in the email group in which the initial subject email 3 is located (that is, the “sports meeting notification” group).

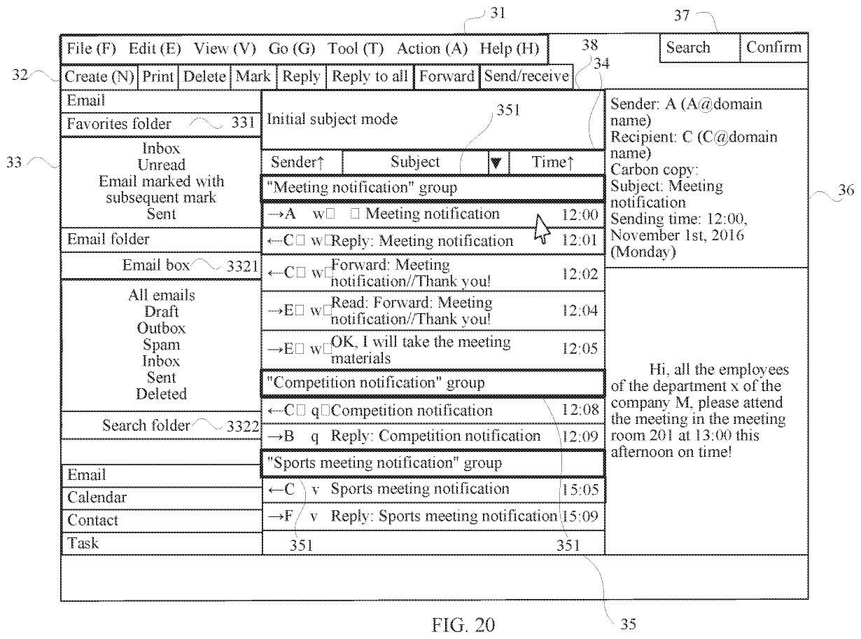

Based on the email grouping result displayed on the display screen of the email box shown in FIG. 19, after the new email (the email 9) is grouped by using the email grouping method in FIG. 17, the terminal device may display a display screen of an email box shown in FIG. 20. As shown in FIG. 20, the “meeting notification” group displayed in the email list area 35 on the display screen of the email may further include the email 9, and the email 9 may include the group identifier 3 (“v”).

Further, in the email grouping method provided in this embodiment of the present invention, after S1707, S1201 in the foregoing embodiment may continue to be performed. That is, in the email grouping method, after the emails in the email box are grouped, the email group may be aggregated, so that the user can check the emails in the email group conveniently.

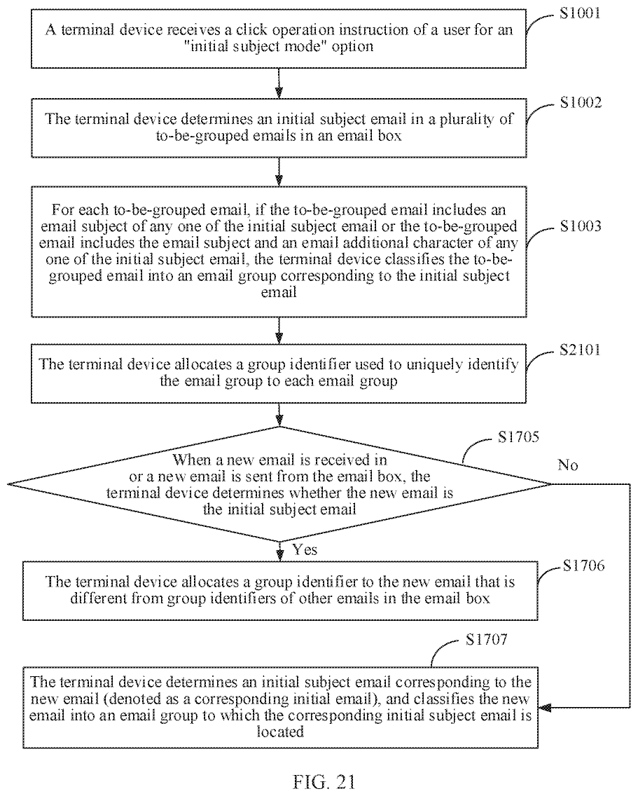

In another embodiment of the present invention, in the “initial subject mode”, the terminal device may continue to group, by using the method shown in FIG. 17 after performing S1003 of grouping the plurality of to-be-grouped emails, the new email received in or sent from the email box. As shown in FIG. 21, the email grouping method may include S1001 to S1103, S2101, and S1705 to S1707.

S2101. The terminal device allocates a group identifier used to uniquely identify the email group to each email group.

For example, the email 1 to the email 9 in FIG. 20 are used as an example. After performing S1001 to S1003, the terminal device may classify the email 1 to the email 5 in the “meeting notification” group, classify the email 6 and the email 7 in the “competition notification” group, and classify the email 8 and the email 9 in the “sports meeting notification” group. Then, the terminal device performs S2101, may allocate the group identifier 1 (“w”) to each of the email 1 to the email 5 in the “meeting notification group”, allocate the group identifier 2 (“q”) to the email 6 and the email 7 in the “competition notification group”, and allocate the group identifier 3 (“v”) to the email 8 and the email 9 in the “sports meeting notification” group.

Further, in the email grouping method provided in this embodiment of the present invention, S1705 to S1707 may continue to be performed after S2101, to group the new email received in or sent from the email box.

Further, in the email grouping method, S1201 may continue to be performed after S2101 and S1705 to S1707, that is, in the email grouping method, after the emails in the email box are grouped, the email group may be aggregated, so that the user may check the emails in the email group conveniently.

The “keyword mode” refers to that the terminal device may receive a subject keyword entered by a user; preferably retrieve an email matching the subject keyword from the email box, to obtain a matching email: and use the matching email as a single group to be displayed on the display screen of the email box to the user. Then, the terminal device may group, by using the email grouping method corresponding to the “initial subject mode”, emails in the email box other than the matching email.

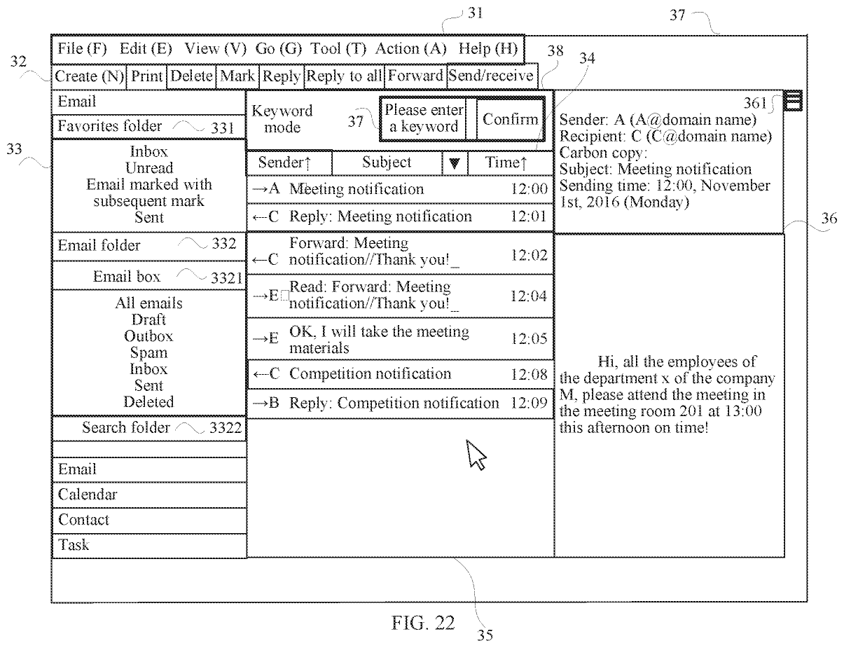

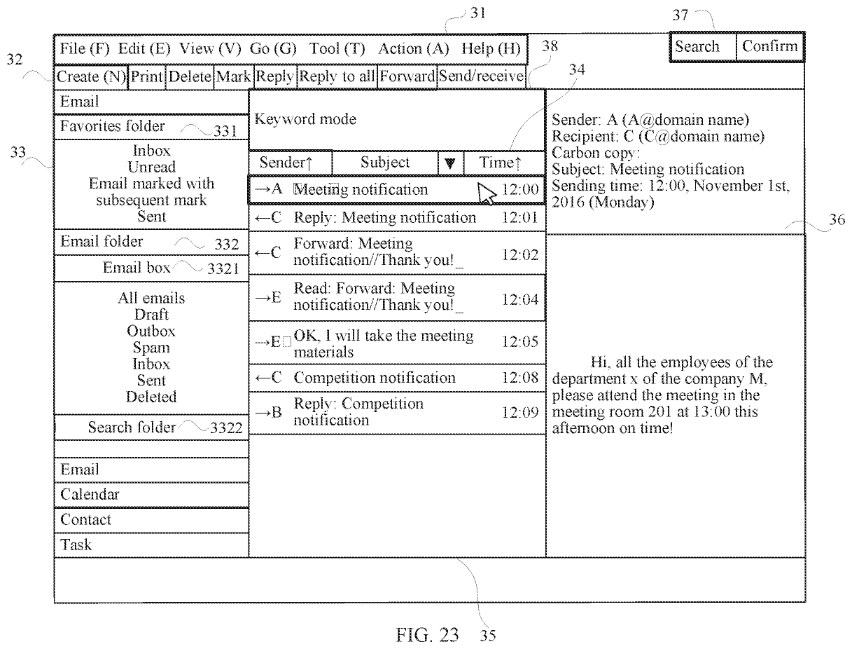

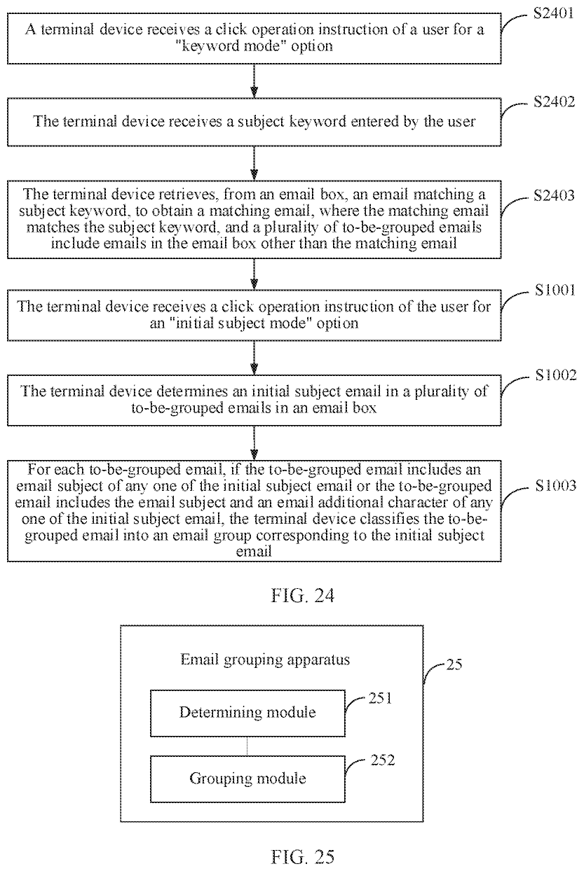

After receiving the click operation instruction of the user for the “keyword mode” in the drop-down window corresponding to the drop-down window option 381 in the email grouping bar 38 in FIG. 9, the terminal device may display a display screen of an email box shown in FIG. 22 or FIG. 23. In addition, in the “initial subject mode”, before the terminal device performs the email grouping method, the email grouping method provided in this embodiment of the present invention may further include S2401 to S2403. For example, as shown in FIG. 24, before S1001 shown in FIG. 10, the email grouping method provided in this embodiment of the present invention may further include S2401 to S2403.

S2401. A terminal device receives a click operation instruction of a user for the “keyword mode” option.

S2402. The terminal device receives a subject keyword entered by the user.

The terminal device may receive, by using a keyword input box shown in FIG. 22 or an input box corresponding to “please enter a keyword” shown in FIG. 23, the subject keyword entered by the user.

For example, the terminal device may receive, by using a search box shown at a right-top corner of a display screen of an email box shown in FIG. 23, the subject keyword entered by the user.

S2403. The terminal device retrieves, from an email box, an email matching a subject keyword, to obtain a matching email, where the matching email matches the subject keyword, and a plurality of to-be-grouped emails include emails in the email box other than the matching email.

In this embodiment of the present invention, before determining the initial subject email and grouping the plurality of to-be-grouped emails, the terminal device may further determine the matching email based on the subject keyword entered by the user, and then group, by using the email grouping method, the emails in the email box other than the matching email.

It should be noted that, the email grouping method provided in this embodiment of the present invention not only may be used to group all the emails in the email box in a unified manner, but also may be used to separately group emails in an inbox, an outbox, a draft box, or a sent email box of the email box. In this embodiment of the present invention, only the unified grouping performed on all the emails in the email box by the terminal device is used as an example, to describe the method in this embodiment of the present invention by using an example. The method in which the terminal device groups the emails in the inbox, the outbox, the draft box, or the sent email box of the email box is similar to the method in which the terminal device groups all the emails in the email box in a unified manner. This is not specifically described in this embodiment of the present invention.

In the email grouping method provided in this embodiment of the present invention, at least one initial subject email may be determined in the plurality of to-be-grouped emails in the email box. The email subject of the initial subject email is included in at least one other email in the plurality of to-be-grouped emails, and the initial subject email does not include an email subject of any one of the at least one other email, that is, the initial subject email in this solution may be an email whose email subject does not include the default character (such as “reply:” and “RE”) and the non-default character (that is, in an email receiving and sending process, a character or a text character that is manually added by the user into an email subject of an email other than the default character). Therefore, for the email group to which any one of the at least one initial subject email belongs, regardless of whether the reply character included in the email subject of the to-be-grouped email is the default character or the non-default character, provided that the to-be-grouped email includes the email subject of the initial subject email, the to-be-grouped email may be classified into the email group. In this way, a problem in the prior art that grouping performed on a plurality of to-be-grouped emails in an email box cannot achieve an expected effect may be resolved.

The foregoing mainly describes the process in which the plurality of emails in the email box are grouped by the terminal device. It may be understood that, to implement the foregoing functions, the terminal device includes a corresponding hardware structure and/or a software module that executes each function. Persons skilled in the art should be easily aware that, in combination with the terminal device and algorithm steps of the examples described in the embodiments disclosed in this specification, the embodiments of the present invention can be implemented by hardware or a combination of hardware and computer software. Whether a function is executed in a mode of hardware or computer software driving hardware depends on particular applications and design constraint conditions of the technical solutions. Persons skilled in the art can use different methods to implement the described functions for each particular application, but it should not be considered that the implementation goes beyond the scope of the embodiments of the present invention.

In the embodiments of the present invention, function module division or functional units division may be performed on the terminal device based on the foregoing method example, for example, each function module or functional unit may be divided corresponding to each function, or two or more functions may be integrated into one processing module. The integrated module may be implemented in a form of hardware, or may be implemented in a form of a software function module or functional unit. The module or unit division in the embodiments of the present invention is an example and is merely logical function, and may be other division during actual implementation.

FIG. 25 is a possible schematic structural diagram of the email grouping apparatus according to the foregoing embodiment. The email grouping apparatus may be the terminal device in the foregoing embodiment, or a control unit or a processing unit that is in the terminal device and that is configured to implement the foregoing email grouping method.

As shown in FIG. 25, the email grouping apparatus 25 may include a determining module 251 and a grouping module 252. The determining module 251 is configured to support the email grouping apparatus 25 in performing S1002 in the foregoing embodiment, and/or is applied to another process of the technology described in the specification. The grouping module 252 is configured to support the email grouping apparatus 25 in performing S1003 in the foregoing embodiment, and/or is applied to another process of the technology described in the specification.

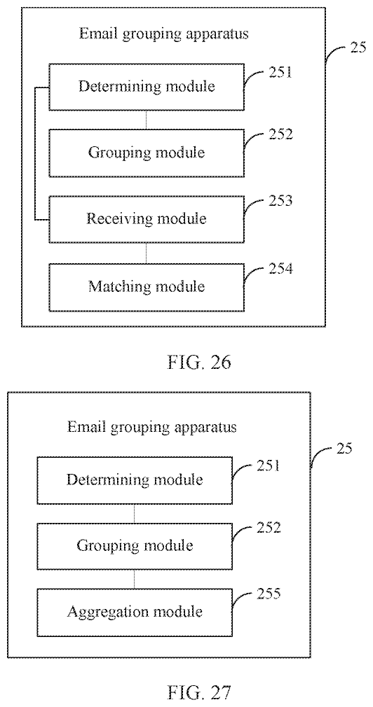

Further, as shown in FIG. 26, the email grouping apparatus 25 may further include a receiving module 253 and a matching module 254. The receiving module 253 is configured to support the email grouping apparatus 25 in performing S1001, S2401, and S2402 in the foregoing embodiment, and/or is applied to another process of the technology described in the specification. The matching module 254 is configured to support the email grouping apparatus 25 in performing S2403 in the foregoing embodiment, and/or is applied to another process of the technology described in the specification.

Further, as shown in FIG. 27, the email grouping apparatus 25 may further include an aggregation module 255. The aggregation module 255 is configured to support the email grouping apparatus 25 in performing S1201 in the foregoing embodiment, and/or is applied to another process of the technology described in the specification.

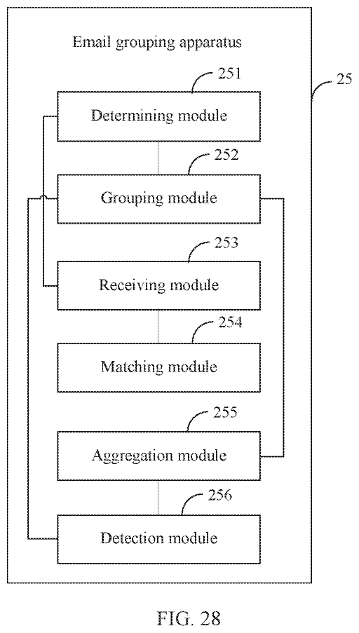

Further, as shown in FIG. 28, the email grouping apparatus 25 may further include a detection module 256. The detection module 256 is configured to support the email grouping apparatus 25 in detecting a new email received in the email box or a new email sent from the email box.

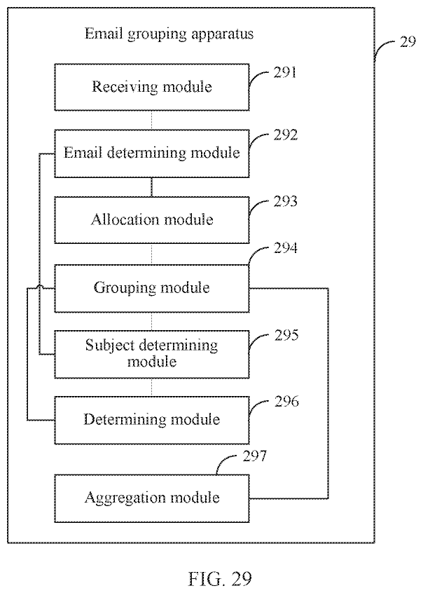

FIG. 29 is a possible schematic structural diagram of another email grouping apparatus according to the foregoing embodiment. The email grouping apparatus may be the terminal device in the foregoing embodiment, or a control unit or a processing unit that is in the terminal device and that is configured to implement the foregoing email grouping method.

As shown in FIG. 29, the email grouping apparatus 29 may include a receiving module 291, an email determining module 292, an allocation module 293, a grouping module 294, a subject determining module 295, a determining module 296, and an aggregation module 297. The receiving module 291 is configured to support the email grouping apparatus 29 in performing S1701 in the foregoing embodiment, and/or is applied to another process of the technology described in the specification. The email determining module 292 is configured to support the email grouping apparatus 29 in performing S1702 in the foregoing embodiment, and/or is applied to another process of the technology described in the specification. The allocation module 293 is configured to support the email grouping apparatus 29 in performing S1703 and S1706 in the foregoing embodiment, and/or is applied to another process of the technology described in the specification. The grouping module 294 is configured to support the email grouping apparatus 29 in performing S1704 and the “classifying the new email in an email group to which the corresponding initial subject email is located” in S1707 in the foregoing embodiment, and/or is applied to another process of the technology described in the specification. The subject determining module 295 is configured to support the email grouping apparatus 29 in performing S1705 in the foregoing embodiment, and/or is applied to another process of the technology described in the specification. The determining module 296 is configured to support the email grouping apparatus 29 in performing “determining a new email corresponding to the initial subject email in the email box” in S1706 in the foregoing embodiment, and/or is applied to another process of the technology described in the specification. The aggregation module 297 is configured to support the email grouping apparatus 29 in performing S1201 in the foregoing embodiment, and/or is applied to another process of the technology described in the specification.

Certainly, the email grouping apparatus provided in this embodiment of the present invention includes but not is limited to the foregoing functional unit. For example, the email grouping apparatus may further include a storage module configured to store the email that is received in or sent from the email box and email grouping information obtained in the email grouping process.

When an integrated unit is used, the determining module 251, the grouping module 252, the receiving module 253, the matching module 254, the aggregation module 255, the detection module 256, and the like may be implemented by being integrated into one processing module. Alternatively, the receiving module 291, the email determining module 292, the allocation module 293, the grouping module 294, the subject determining module 295, the determining module 296, and the aggregation module 297 may be implemented by being integrated into one processing module. The foregoing processing module may be a processor or a controller, for example, may be a CPU, a general purpose processor, a digital signal processor (English: Digital Signal Processor, DSP for short), an application-specific integrated circuit (English: Application-Specific Integrated Circuit, ASIC for short), a field programmable gate array (English: Field Programmable Gate Array, FPGA for short) or another programmable logic component, a transistor logic device, a hardware component, or any combination thereof. The foregoing processing module may implement or execute logical blocks, modules, and circuits described with reference to the various examples described in the disclosed content of the present invention. The foregoing processing unit may be a combination for implementing a calculation function, for example, includes a combination of one or more of microprocessors, a combination of a DSP and a microprocessor, or the like. The storage module may be a memory.

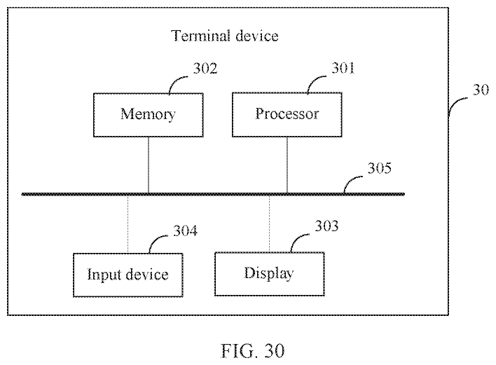

When the foregoing processing module is a processor, and the storage module is a memory, an embodiment of the present invention provides a terminal device 30 shown in FIG. 30. As shown in FIG. 30, the terminal device 30 includes a processor 301, a memory 302, a display 303, an input device 304, and a bus 305. The processor 301, the memory 302, the display 303, and the input device 304 are connected to each other by using the bus 305. The bus 305 may be a peripheral component interconnect (English: Peripheral Component Interconnect, PCI for short) bus, an extended industry standard architecture (English: Extended Industry Standard Architecture, EISA for short) bus, or the like. The bus 305 may be classified into an address bus, a data bus, a control bus, and the like. For ease of representation, only a bold line is used for representation in FIG. 30, but it does not represent that there is only one bus or one type of buses.

For example, the input device 304 may include components such as a mouse, a physical keyboard, a trackball, a touch panel, and a joystick. For example, an input device in a PC may include a mouse, a physical keyboard, a physical keyboard, and the like. An input device in the foregoing mobile phone or the tablet computer may include a touch panel, a joystick, and the like. The display 303 may be an independent component, or may further be integrated with the input device 304 to be one component. For example, the display panel in the mobile phone or the tablet computer may be the touch panel of the mobile phone or the tablet computer.

An embodiment of the present invention further provides a nonvolatile storage medium, and the nonvolatile storage medium stores one or more pieces of program code. When the processor 301 of the terminal device 30 executes the program code, the terminal device 30 performs related method steps in the foregoing embodiments.

For detailed descriptions of the modules in the terminal device 30 provided in this embodiment of the present invention and technical effects brought by performing related method steps of the foregoing embodiment by the modules, refer to related descriptions in the method embodiment of the present invention, and details are not described herein again.

The foregoing descriptions about implementations allow persons skilled in the art to understand that, for the purpose of convenient and brief description, division of the foregoing function modules is taken as an example for illustration. In actual application, the foregoing functions can be allocated to different modules and implemented according to a requirement, that is, an inner structure of an apparatus is divided into different function modules to implement all or part of the functions described above. For a detailed working process of the foregoing system, apparatus, and unit, refer to a corresponding process in the foregoing method embodiments, and details are not described herein again.

In the several embodiments provided in the present invention, it should be understood that the disclosed system, apparatus, and method may be implemented in other manners. For example, the described apparatus embodiment is merely an example. For example, the module division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

Function modules in the embodiments of the present invention may be integrated into one processing module, or each unit may exist alone physically, or two or more modules are integrated into one unit. The integrated module may be implemented in a form of hardware, or may be implemented in a form of a software function module.

When the foregoing integrated unit is implemented in the form of a software functional unit and sold or used as an independent product, the integrated unit may be stored in a computer-readable storage medium. Based on such an understanding, the technical solutions of the present invention essentially, or the part contributing to the prior art, or all or a part of the technical solutions may be implemented in the form of a software product. The software product is stored in a storage medium and includes several instructions for instructing a computer device (which may be a personal computer, a server, or a network device) or a processor to perform all or a part of the steps of the email grouping methods described in the embodiments of the present invention. The foregoing storage medium includes: any medium that can store program code, such as a USB flash drive, a removable hard disk, a read-only memory (Read-Only Memory, ROM for short), a random access memory (Random Access Memory. RAM for short), a magnetic disk, or an optical disc.

The foregoing descriptions are merely specific embodiments of the present invention, but are not intended to limit the protection scope of the embodiments of the present invention. Any variation or replacement readily figured out by persons skilled in the art within the technical scope disclosed in the present invention shall fall within the protection scope of the present invention. Therefore, the protection scope of the embodiments of the present invention shall be subject to the protection scope of the claims.

1. An email grouping method, comprising:
determining at least one initial subject email in a plurality of to-be-grouped emails in an email box, wherein a first email subject of each of the at least one initial subject email is comprised in at least one other email in the to-be-grouped emails, and wherein the at least one initial subject email does not comprise a second email subject of any one of the at least one other email; and
classifying, for each of the to-be-grouped emails, a to-be-grouped email into an email group corresponding to the at least one initial subject email when the to-be-grouped email comprises the first email subject and an email additional character of the at least one initial subject email, wherein each of the at least one initial subject email corresponds to one email group, and wherein the email additional character comprises a default character and a non-default character.

2. The email grouping method of claim 1, wherein before determining the at least one initial subject email, the email grouping method further comprises:
receiving a subject keyword from a user; and
retrieving an email matching the subject keyword from the email box to obtain at least one matching email, wherein each of the at least one matching email matches the subject keyword, and wherein the to-be-grouped emails comprise emails in the email box other than the at least one matching email.

3. The email grouping method of claim 1, wherein after classifying the to-be-grouped emails into the email group, the email grouping method further comprises aggregating all emails in each email group into one aggregated email based on a chronological order of email sending time, and wherein the aggregated email corresponding to each email group comprises information about all emails in a corresponding email group.

4. The email grouping method of claim 3, wherein that the first email subject is comprised in the at least one other email in the to-be-grouped emails comprises that the first email subject is comprised in an email body or an email subject of the at least one other email in the to-be-grouped emails, and wherein that the at least one initial subject email does not comprise the second email subject comprises that neither an email subject nor an email body of each of the at least one initial subject email comprises the second email subject.

5. The email grouping method of claim 1, further comprising:
detecting a new email received in the email box or the new email sent from the email box; and
classifying the new email into the email group corresponding to the at least one initial subject email when the new email comprises the first email subject.

6. The email grouping method of claim 5, wherein after classifying the new email into the email group corresponding to the at least one initial subject email, the email grouping method further comprises aggregating, based on a chronological order of email sending time, the new email and an aggregated email corresponding to the email group to which the new email belongs into a new aggregated email, and wherein the new aggregated email comprises information about the new email and information about the aggregated email.

7.-13. (canceled)

14. A mobile phone, comprising:
one or more processors; and
a memory coupled to the one or more processors and configured to store instructions which, when executed by the one or more processors, cause the mobile phone to:
determine at least one initial subject email in a plurality of to-be-grouped emails in an email box, wherein a first email subject of each of the at least one initial subject email is comprised in at least one other email in the to-be-grouped emails, and wherein the at least one initial subject email does not comprise a second email subject of any one of the at least one other email; and
classify, for each of the to-be-grouped emails, a to-be-grouped email into an email group corresponding to the at least one initial subject email when the to-be-grouped email comprises the first email subject and an email additional character of the at least one initial subject email, wherein each of the at least one initial subject email corresponds to one email group, and wherein the email additional character comprises a default character and a non-default character.

15. The mobile phone of claim 14, wherein before determining the at least one initial subject email, the instructions, when executed by the one or more processors, further cause the mobile phone to:
receive a subject keyword from a user; and
retrieve an email matching the subject keyword from the email box to obtain at least one matching email, wherein each of the at least one matching email matches the subject keyword, and wherein the to-be-grouped emails comprise emails in the email box other than the at least one matching email.

16. The mobile phone of claim 14, wherein the instructions, when executed by the one or more processors, further cause the mobile phone to aggregate all emails in each email group into one aggregated email based on a chronological order of email sending time, and wherein the aggregated email corresponding to each email group comprises information about all emails in a corresponding email group.

17. The mobile phone of claim 14, wherein that the first email subject is comprised in the at least one other email in the to-be-grouped emails comprises that the first email subject is comprised in an email body or an email subject of the at least one other email in the to-be-grouped emails, and wherein that the at least one initial subject email does not comprise the second email subject comprises that neither an email subject nor an email body of each of the at least one initial subject email comprises the second email subject.

18. The mobile phone of claim 14, wherein the instructions, when executed by the one or more processors, further cause the mobile phone to:
detect a new email received in the email box or the new email sent from the email box; and
classify the new email into the email group corresponding to the at least one initial subject email when the new email comprises the first email subject.

19. The mobile phone of claim 18, wherein the instructions, when executed by the one or more processors, further cause the mobile phone to aggregate, based on a chronological order of email sending time, the new email and an aggregated email corresponding to the email group to which the new email belongs into a new aggregated email, wherein the new aggregated email comprises information about the new email and information about the aggregated email.

20. A computer program product comprising a non-transitory computer readable storage medium storing program code thereon for email grouping, wherein the program code comprises instructions for executing a method that comprises:
determining at least one initial subject email in a plurality of to-be-grouped emails in an email box, wherein a first email subject of each of the at least one initial subject email is comprised in at least one other email in the to-be-grouped emails, and wherein the at least one initial subject email does not comprise a second email subject of any one of the at least one other email; and
classifying, for each of the to-be-grouped emails, a to-be-grouped email into an email group corresponding to the at least one initial subject email when the to-be-grouped email comprises the first email subject and an email additional character of the at least one initial subject email, wherein each of the at least one initial subject email corresponds to one email group, and wherein the email additional character comprises a default character and a non-default character.

21. The computer program product of claim 20, wherein the method further comprises:
receiving a subject keyword from a user; and
retrieving an email matching the subject keyword from the email box to obtain at least one matching email, wherein each of the at least one matching email matches the subject keyword, and wherein the to-be-grouped emails comprise emails in the email box other than the at least one matching email.

22. The computer program product of claim 20, wherein the method further comprises aggregating all emails in each email group into one aggregated email based on a chronological order of email sending time, and wherein an aggregated email corresponding to each email group comprises information about all emails in a corresponding email group.

23. The computer program product of claim 20, wherein that the first email subject is comprised in the at least one other email in the to-be-grouped emails comprises that the first email subject is comprised in an email body of the at least one other email in the to-be-grouped emails, and wherein that the at least one initial subject email does not comprise the second email subject comprises that an email body of each of the at least one initial subject email does not comprise the second email subject.

24. The computer program product of claim 20, wherein that the first email subject is comprised in the at least one other email in the to-be-grouped emails comprises that the first email subject is comprised in an email subject of the at least one other email in the to-be-grouped emails, and wherein that the at least one initial subject email does not comprise the second email subject comprises that an email subject of each of the at least one initial subject email does not comprise the second email subject.

25. The computer program product of claim 20, wherein the method further comprises:
detecting a new email received in the email box; and
classifying the new email into the email group corresponding to the at least one initial subject email when the new email comprises the first email subject.

26. The computer program product of claim 20, wherein the method further comprises:
detecting a new email sent from the email box; and
classifying the new email into the email group corresponding to the at least one initial subject email when the new email comprises the first email subject.

27. The computer program product of claim 26, wherein the method further comprises aggregating, based on a chronological order of email sending time, the new email and an aggregated email corresponding to the email group to which the new email belongs into a new aggregated email, and wherein the new aggregated email comprises information about the new email and information about the aggregated email.
